(19) United States
(12) Patent Application Publication
(10) Pub. No.: US 2011/0007187 A1
(43) Pub. Date: Jan. 13, 2011

(54) Imaging Device And Image Playback Device

(75) Inventors: Yukio Mori, Osaka (JP); Yasuhachi Hamamoto, Osaka (JP)

Correspondence Address: NDQ&M WATCHSTONE LLP, 300 NEW JERSEY AVENUE, NW, FIFTH FLOOR, WASHINGTON, DC, 20001, US

(73) Assignee: SANYO ELECTRIC CO., LTD., Osaka (JP)

(21) Appl. No.: 12/921,904

(22) PCT Filed: Feb. 24, 2009
(86) PCT No.: PCT/JP2009/053243

§ 371 Date: Sep. 10, 2010

(30) Foreign Application Priority Data
Mar. 10, 2008 (JP) 2008-059756

(51) Int. Cl. H04N 5/262; H04N 5/228

(52) U.S. Cl. 348/239; 348/222.1; 348/E05.055

(57) ABSTRACT

An imaging device includes: an imaging element which outputs a signal based on an optical image projected to the imaging element by imaging; a correction lens which moves the optical image on the imaging element; a face detection unit which detects a person's face as an object from a judgment image based on the output signal from the imaging element and detects the position and the direction of the face in the judgment image; and an imaging control unit which controls the position of the correction lens in accordance with the position and the direction of the detected face. A layout-adjusted image is generated from the output signal from the imaging element after the control. More specifically, the position of the correction lens is controlled so as to obtain a layout-adjusted image of the golden cut when an attention is paid on the face position. Moreover, the position of the correction lens is controlled so as to increase the space in the direction in which the face is directed.

### TECHNICAL FIELD

The present invention relates to an imaging device such as a digital still camera, and an image playback device that plays back images.

### BACKGROUND ART

Imaging devices such as digital still cameras have recently been widely used, and users of such imaging devices can enjoy shooting a subject such as a person without difficulty. However, it is difficult particularly for a beginner of shooting to set a shooting composition, and in many cases, an image (for example, an image of high artistic quality) having a preferable composition cannot be obtained under conditions (including the composition) set by users. Accordingly, a function of automatically acquiring an image having a preferable composition that is suitable for the state of a subject would be helpful to users.

There has been proposed a method in which final shooting is carried out after a position of a characteristic part (such as the nose) of a person is detected from an input image obtained from a CCD, and the position of the CCD is driven and controlled such that the characteristic part is placed at a target position on the image (see Patent Document 1 listed below). This method is designed for obtaining an image for face recognition. This method makes it possible to obtain an image in which, for example, a face is located in the middle, and thus may be useful as a technology for face recognition. However, it can hardly be said that such a composition of an image is preferable when a general user takes a photograph of a person.

There has also been proposed a method in which zoom control of a camera is performed along with the panning and/or tilting of the camera so as to locate the characteristic part of a face within a reference region in a frame and so as for the face to have a predetermined size within the frame (see Patent Document 2 listed below). This method as well is designed for obtaining an image for face recognition. The method makes it possible to obtain an image in which, for example, a face is located in the middle and the size of the face is constant, and thus may be useful as a technology for face recognition. However, it can hardly be said that such a composition of an image is preferable when a general user takes a photograph of a person. In addition, this method requires a mechanism for panning and tilting a camera, and thus is difficult to be applied to imaging devices aimed for general users.

There has also been proposed a method in which, when a shutter release button is pressed, a zoom lens is driven and controlled such that the angle of view is wider than set by a user, and then a CCD shoots a wide-angle image, from which a plurality of images are cut out (see Patent Document 3 listed below). However, with this method, since a clipping position is set regardless of the state of the subject, it is impossible to obtain an image having a composition suitable for the state of the subject.

Patent Document 1: JP-A-2007-36436

Patent Document 2: JP-A-2005-117316

Patent Document 3: JP-A-2004-109247

### DISCLOSURE OF THE INVENTION

### Problems To Be Solved By the Invention

In view of the foregoing, an object of the present invention is to provide an imaging device which contributes to acquiring an image having a preferable composition that is suitable for the state of a subject. Another object of the present invention is to provide an image playback device which contributes to playing back an image having a preferable composition that is suitable for the state of a subject included in an input image.

### Means For Solving the Problem

A first imaging device according to the present invention is provided with: an image sensor which outputs a signal corresponding to an optical image projected on the image sensor itself by shooting; an image moving portion which moves the optical image on the image sensor; a face detection portion which detects a face of a person as a subject from a judgment image which is based on an output signal of the image sensor, and detects a position and an orientation of the face on the judgment image; and a composition control portion which performs control of the image moving portion based on a detected position and a detected orientation of the face, and generates a composition adjustment image from the output signal of the image sensor after the control.

With this structure, it is possible to expect generation of a composition adjustment image having a preferable composition adjusted according to the position and the orientation of the face.

Specifically, for example, it is preferable that the composition control portion control the image moving portion such that a target point corresponding to the detected position of the face is placed at a specific position on the composition adjustment image, and that the composition control portion set the specific position based on the detected orientation of the face.

Also, specifically, for example, it is preferable that the composition control portion set the specific position, with respect to a center of the composition adjustment image, close to a side opposite from a side toward which the face is oriented.

Generally, in photography shooting, it is thought that a good composition is one in which there is a wider space on a side toward which the face is oriented. In view of this, the specific position is set, with respect to a center of the composition adjustment image, close to a side opposite from a side toward which the face is oriented. This makes it possible to acquire a composition adjustment image which seems to have a preferable composition.

Also, specifically, for example, it is preferable that the specific position be any one of positions of four intersection points formed by two lines which divide the composition adjustment image in a horizontal direction into three equal parts and two lines which divide the composition adjustment image in a vertical direction into three equal parts.

This makes it possible to automatically acquire an image having a composition of the so-called golden section.

Also, for example, it is preferable that the composition control portion generate one or more composition adjustment images as the composition adjustment image, and that the composition control portion determine, based on the detected orientation of the face, a number of the composition adjustment images to be generated.

More specifically, for example, it is preferable that, in a case where it is assumed that m is an integer of 2 or more and n is an integer of 2 or more but less than m, in response to the face being detected to be oriented frontward, the composition control portion set m specific positions which are different from each other, and generate a total of m composition adjustment images corresponding to the m specific positions, and that, on the other hand, in response to the face being detected to be laterally oriented, the composition control portion set one specific position and generate one composition adjustment image, or alternatively, that the composition control portion set n specific positions which are different from each other and generate a total of n composition adjustment images corresponding to the n specific positions.

This contributes to, for example, reducing the necessary processing time.

Unless inconsistent, any feature in the first imaging device is applicable to a second imaging device which will be described later.

Also, for example, it is preferable that the first imaging device be further provided with: a shooting instruction receiving portion which receives a shooting instruction from outside; and a record control portion which performs record control for recording, to a recording medium, image data based on the output signal of the image sensor. Here, the composition control portion generates the composition adjustment image according to the shooting instruction, and also generates, from the output signal of the image sensor, a basic image which is different from the composition adjustment image, and the record control portion makes the recording medium record image data of the composition adjustment image and image data of the basic image such that the image data of the composition adjustment image and the image data of the basic image are associated with each other.

A second imaging device according to the present invention is provided with: an image sensor which outputs a signal corresponding to an optical image projected on the image sensor itself by shooting; a face detection portion which detects a face of a person as a subject from a judgment image which is based on an output signal of the image sensor, and detects a position and an orientation of the face on the judgment image; and a composition control portion which handles, as a basic image, the judgment image, or an image which is obtained from the output signal of the image sensor and which is different from the judgment image, and generates a composition adjustment image by cutting out part of the basic image. Here, the composition control portion controls a clipping position of the composition adjustment image based on a detected position and a detected orientation of the face.

With this structure, it is possible to expect generation of a composition adjustment image having a preferable composition adjusted according to the position and the orientation of the face.

Specifically, for example, it is preferable that, in the second imaging device, the composition control portion control the clipping position such that a target point corresponding to the detected position of the face is placed at a specific position on the composition adjustment image, and that the composition control portion set the specific position based on the detected orientation of the face.

Furthermore, for example, it is preferable that the second imaging device be further provided with: a shooting instruction receiving portion which receives a shooting instruction from outside; and a record control portion which performs record control for recording, to a recording medium, image data based on the output signal of the image sensor. Here, the composition control portion generates the basic image and the composition adjustment image according to the shooting instruction, and the record control portion makes the recording medium record image data of the composition adjustment image and image data of the basic image such that the image data of the composition adjustment image and the image data of the basic image are associated with each other.

An image playback device according the present invention is provided with: a face detection portion which detects a face of a person from an input image, and detects a position and an orientation of the face on the input image; and a composition control portion which outputs image data of a composition adjustment image obtained by cutting out part of the input image. Here, the composition control portion controls a clipping position of the composition adjustment image based on a detected position and a detected orientation of the face.

### Advantages of the Invention

According to the present invention, it is possible to provide an imaging device which contributes to acquiring an image having a preferable composition that is suitable for the state of a subject. Furthermore, it is also possible to provide an image playback device that contributes to playing back an image having a preferable composition that is suitable for the state of a subject included in an input image.

The significance and benefits of the invention will be clear from the following description of its embodiments. It should however be understood that these embodiments are merely examples of how the invention is implemented, and that the meanings of the terms used to describe the invention and its features are not limited to the specific ones in which they are used in the description of the embodiments.

### BRIEF DESCRIPTION OF DRAWINGS

FIG. 1 An overall block diagram of an imaging device embodying the present invention;

FIG. 2 A diagram showing the internal structure of an image sensing portion shown in FIG. 1;

FIG. 3 Diagrams, where (a) and (b) show how an optical image moves on an image sensor along with movement of a correction lens of FIG. 2;

FIG. 4 A diagram for defining, in connection with an image, top, bottom, right and left sides;

FIG. 5 A partial function block diagram of the imaging device of FIG. 1, showing blocks involved in a first composition-adjustment shooting operation;

FIG. 6 Diagrams of images, where (a) shows a face oriented toward the front, (b) shows a face oriented toward the left, and (c) shows a face oriented toward the right;

FIG. 7 A flow chart showing a flow of the first composition-adjustment shooting operation;

FIG. 8 Diagrams, in connection with the first composition-adjustment shooting operation, where one is a plan view of a subject on which a shooting range of the imaging device is superposed, and the other shows a judgment image with respect to which face detection processing is executed;

FIG. 9 A diagram showing a given image of interest, two lines dividing the image into three equal parts in the up-down direction, two lines dividing the image into three equal parts in the left-right direction, and four intersection points formed by these lines;

FIG. 10 Diagrams, where (a), (b), (c), (d) and (e) show a basic image, first, second, third and fourth composition adjustment images, respectively, generated by the first composition-adjustment shooting operation;

FIG. 11 Diagrams, where (a) and (b) show two images as examples of a composition adjustment image which can be generated by a second composition-adjustment shooting operation;

FIG. 12 A diagram showing an image as an example of a composition adjustment image generated by the second composition-adjustment shooting operation;

FIG. 13 Diagrams, where (a) and (b) show a basic image and a composition adjustment image, respectively, generated by the second composition-adjustment shooting operation;

FIG. 14 A partial function block diagram of the imaging device of FIG. 1, showing blocks involved in a third composition-adjustment shooting operation;

FIG. 15 A flow chart showing a flow of the third composition-adjustment shooting operation;

FIG. 16 Diagrams, where (a) shows a basic image generated by the third composition-adjustment shooting operation, and (b), (c), (d) and (e) show first, second, third and fourth clipped images, respectively, which can be generated by the third composition-adjustment shooting operation;

FIG. 17 A diagram showing the structure of an image file recorded to the external memory shown in FIG. 1;

FIG. 18 Diagrams showing image files formed according to a first recording format;

FIG. 19 Diagrams showing image files formed according to a second recording format;

FIG. 20 A partial function block diagram of the imaging device of FIG. 1, showing blocks involved in an automatic-trimming playback operation; and

FIG. 21 A flow chart showing a flow of the automatic-trimming playback operation.

### LIST OF REFERENCE SYMBOLS

1 imaging device

11 image sensing portion

33 image sensor

36 correction lens

51, 61, 71 face detection portion

52 shooting control portion

53 image acquisition portion

54, 64 record control portion

62, 72 clipping region setting portion

63, 73 clipping portion

### BEST MODE FOR CARRYING OUT THE INVENTION

Hereinafter, embodiments of the present invention will be described specifically with reference to the drawings. Among different drawings referred to in the course of description, the same parts are identified by the same reference signs, and, in principle, no overlapping description of the same parts will be repeated.

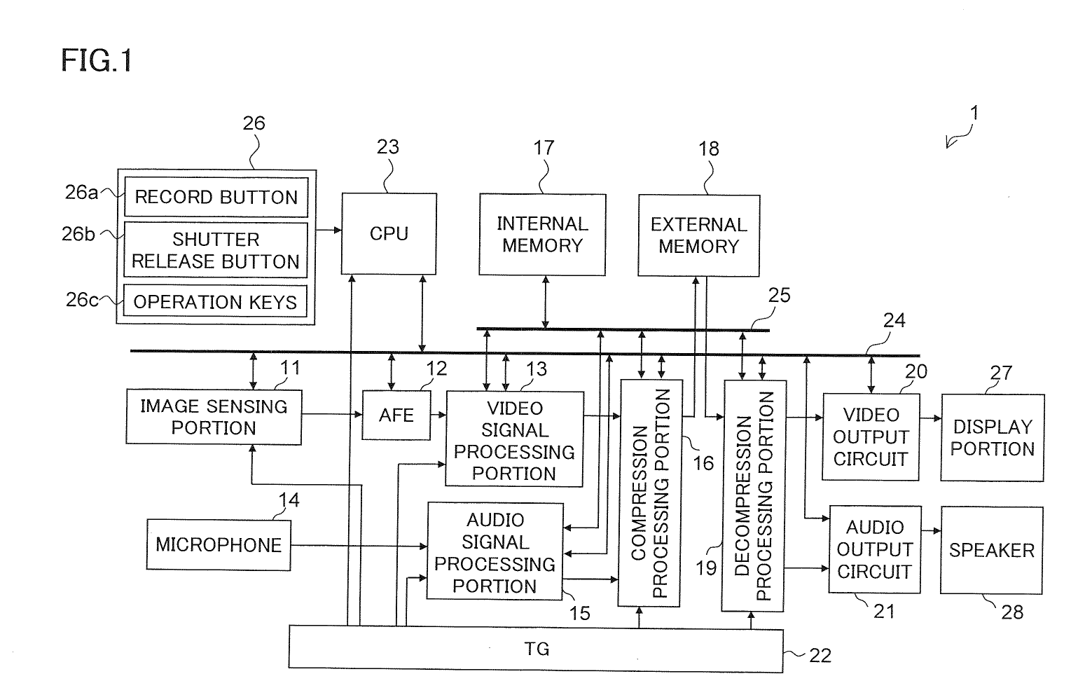

FIG. 1 is an overall block diagram of an imaging device 1 embodying the present invention. The imaging device 1 is for example a digital video camera. The imaging device 1 is capable of shooting both moving and still images. The imaging device 1 is also capable of shooting a still image simultaneously with the shooting of a moving image. Incidentally, the moving image shooting function may be omitted to make the imaging device 1 a digital still camera that is merely capable of shooting still images.

[Basic Structure]

The imaging device 1 includes: an image sensing portion 11; an AFE (analog front end) 12; a video signal processing portion 13; a microphone 14; an audio signal processing portion 15; a compression processing portion 16; an internal memory 17 such as a DRAM (dynamic random access memory), an SDRAM (synchronous dynamic random access memory) or the like; an external memory 18 such as an SD (secure digital) card, a magnetic disc, or the like; a decompression processing portion 19; a video output circuit 20; an audio output circuit 21; a TG (a timing generator) 22; a CPU (central processing unit) 23; a bus 24; a bus 25; an operation portion 26; a display portion 27; and a speaker 28. The operation portion 26 includes a record button 26a, a shutter release button 26b, operation keys 26c and the like. The different portions within the imaging device 1 exchange signals (data) via the bus 24 or 25.

The TG 22 generates timing control signals for controlling the timing of different operations in the entire imaging device 1, and feeds the generated timing control signals to different portions within the imaging device 1. The timing control signals include a vertical synchronizing signal Vsync and a horizontal synchronizing signal Hsync. The CPU 23 controls operations of different portions within the imaging device 1 in a concentrated fashion. The operation portion 26 receives operation by a user. How the operation portion 26 is operated is conveyed to the CPU 23. Different portions within the imaging device 1 temporarily store various kinds of data (digital signals) in the internal memory 17, as necessary, in processing signals.

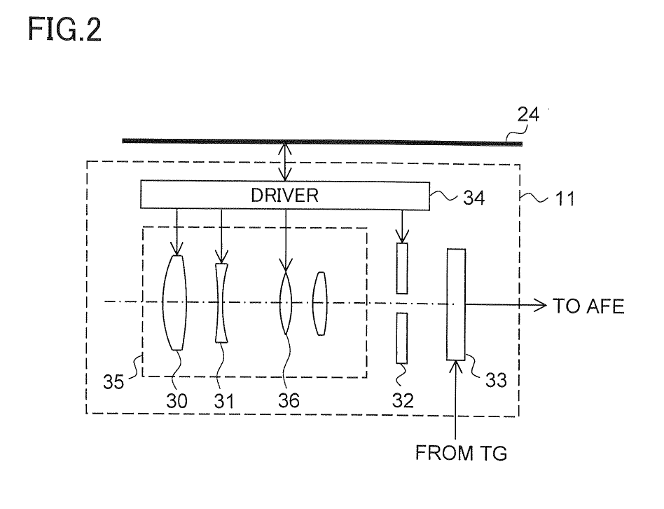

FIG. 2 is a diagram showing the internal structure of the image sensing portion 11 shown in FIG. 1. The imaging device 1 is structured, by providing the image sensing portion 11 with a color filter or the like, such that the imaging device 1 can generate color images by shooting.

The image sensing portion 11 includes an optical system 35, an aperture stop 32, an image sensor 33, and a driver 34. The optical system 35 is composed of a plurality of lenses including a zoom lens 30, a focus lens 31, and a correction lens 36. The zoom lens 30 and the focus lens 31 are movable along an optical axis, and the correction lens 36 is movable along a direction tilted with respect to the optical axis. Specifically, the correction lens 36 is disposed within the optical system 35 so as to be movable on a two-dimensional plane perpendicular to the optical axis.

Based on a control signal from the CPU 23, the driver 34 drives the zoom lens 30 and the focus lens 31 to control their positions, and drives the aperture stop 32 to control its aperture size; the driver 34 thereby controls the focal length (angle of view) and focus position of the image sensing portion 11 and the amount of light that the imaging element 33 receives. The light from a subject is incident on the image sensor 33 via the lenses of the optical system 35 and the aperture stop 32. The lenses constituting the optical system 35 form an optical image of the subject on the image sensor 33. The TG 22 generates drive pulses for driving the image sensor 33 in synchronism with the timing control signals mentioned above, and feeds the drive pulses to the image sensor 33.

The image sensor 33 is formed with, for example, a CCD (charge-coupled device) image sensor, a CMOS (complementary metal oxide semiconductor) image sensor, or the like. The image sensor 33 photoelectrically converts the optical image incident through the optical system 35 and the aperture stop 32, and outputs electrical signals obtained by the photoelectric conversion to the AFE 12. More specifically, the image sensor 33 is provided with a plurality of light-receiving pixels arrayed in a two-dimensional matrix, each light-receiving pixel accumulating, in each shooting, an amount of signal charge commensurate with the time of exposure. Having magnitudes proportional to the amounts of signal charge accumulated respectively, the electrical signals from the individual light-receiving pixels are, in accordance with the drive pulses from the TG 22, sequentially fed to the AFE 12 provided in the succeeding stage. In a case where the optical image incident on the optical system 35 remains the same and so does the aperture size of the aperture stop 32, the magnitude (intensity) of the electrical signals from the image sensor 33 increases proportionally with the above-mentioned exposure time.

The AFE 12 amplifies the electric signals (analog signals) outputted from the image sensor 33, converts the amplified analog signals into digital signals, and then outputs the digital signals to the video signal processing portion 13. The amplification degree of the signal amplification performed by the AFE 12 is controlled by the CPU 23. The video signal processing portion 13 applies various kinds of image processing to an image represented by the signals outputted from the AFE 12, and generates a video signal representing the image having undergone the image processing. The video signal is composed of a luminance signal Y, which represents the luminance of the image, and color difference signals U and V, which represent the color of the image.

The microphone 14 converts sounds around the imaging device 1 into an analog audio signal. The audio signal processing portion 15 converts the analog audio signal into a digital audio signal.

The compression processing portion 16 compresses the video signal from the video signal processing portion 13 by a predetermined compression method. In shooting and recording a moving or still image, the compressed video signal is recorded to the external memory 18. The compression processing portion 16 also compresses the audio signal from the audio signal processing portion 15 by a predetermined compression method. In the shooting and recording of a moving image, the video signal from the video signal processing portion 13 and the audio signal from the audio signal processing portion 15 are compressed, while being temporarily associated with each other, by the compression processing portion 16, so as to be recorded, after the compression, to the external memory 18.

The record button 26a is a push button switch for instructing starting/ending the shooting and recording of a moving image. The shutter release button 26b is a push button switch for instructing the shooting and recording of a still image.

The imaging device 1 operates in different operation modes including a shooting mode, in which it can shoot moving and still images, and a playback mode, in which it plays back and displays on the display portion 27 moving and still images stored in the external memory 18. Switching between the different operation modes is performed according to an operation performed on the operation keys 26c. In the shooting mode, shooting is performed sequentially at a predetermined frame period, and the image sensor 33 acquires a series of chronologically ordered images. Each image forming the series of images is called a “frame image.”

In the shooting mode, when the user presses the record button 26a, under the control of the CPU 23, video signals of one frame image after another obtained after the pressing are, along with the corresponding audio signals, sequentially recorded to the external memory 18 via the compression processing portion 16. After the shooting of a moving image is started, when the user presses the record button 26a again, the recording of the video and audio signals to the external memory 18 is ended, and the shooting of one moving image is completed. On the other hand, when the user presses the shutter release button 26b in the shooting mode, a still image is shot and recorded.

In the playback mode, when the user applies a predetermined operation to the operation keys 26c, a compressed video signal stored in the external memory 18 representing a moving image or a still image is decompressed by the decompression processing portion 19, and is then fed to the video output circuit 20. Incidentally, in the shooting mode, normally, regardless of how the record button 26a and the shutter release button 26b are operated, the video signal processing portion 13 keeps generating a video signal, which is fed to the video output circuit 20.

The video output circuit 20 converts the digital video signal fed thereto into a video signal having a format displayable on the display portion 27 (e.g., an analog video signal), and then outputs the result. The display portion 27 is a display device including a liquid crystal display panel, an integrated circuit for driving it, and the like, and displays an image according to the video signal outputted from the video output circuit 20.

In playing back a moving image in the playback mode, a compressed audio signal stored in the external memory 18 corresponding to the moving image is also fed to the decompression processing portion 19. The decompression processing portion 19 decompresses the audio signal fed thereto, and feeds the result to the audio output circuit 21. The audio output circuit 21 converts the audio signal (digital signal) fed thereto into an audio signal having a format that can be outputted from the speaker 28 (e.g., an analog audio signal), and outputs the result to the speaker 28. The speaker 28 outputs sound to the outside according to the audio signal from the audio output circuit 21.

Incidentally, the video signal from the video output circuit 20 and the audio signal from the audio output circuit 21 may instead be fed, via external output terminals (not shown) provided in the imaging device 1, to an external apparatus (such as an external display device).

The shutter release button 26b can be pressed in two steps; that is, when a shooter lightly presses the shutter release button 26b, the shutter release button 26b is brought into a half-pressed state, and when the shooter presses the shutter release button 26b further from the half-pressed state, the shutter release button 26b is brought into a fully-pressed state.

As mentioned above, the correction lens 36 is disposed within the optical system 35 so as to be movable on a two-dimensional plane perpendicular to the optical axis. Thus, along with the movement of the correction lens 36, an optical image projected on the image sensor 33 moves on the image sensor 33 in a two-dimensional direction that is parallel to the image sensing surface of the image sensor 33. The image sensing surface is a surface on which the light-receiving pixels of the image sensor 33 are arranged, and onto which an optical image is projected. The CPU 23 feeds the driver 34 with a lens-shift signal for shifting the position of the correction lens 36, and the driver 34 moves the correction lens 36 according to the lens-shift signal. The movement of the correction lens 36 causes the optical axis to shift, and hence the control for moving the correction lens 36 is called “optical-axis shift control.”

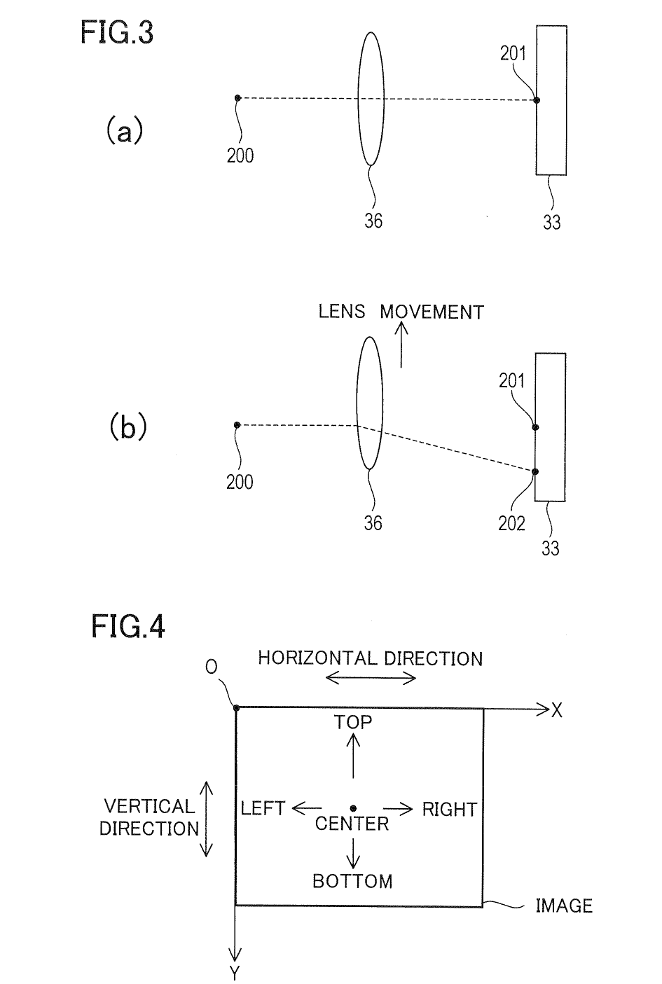

FIGS. 3(a) and (b) show how an optical image moves along with the movement of the correction lens 36. Light from a point 200 that remains stationary in a real space is incident on the image sensor 33 via the correction lens 36, and an optical image of the point 200 is formed at a given point on the image sensor 33. In the state shown in FIG. 3(a), the optical image is formed at a point 201 on the image sensor 33, but when the position of the correction lens 36 is shifted from the position as in the state shown in FIG. 3(a) to a position as in the state shown in FIG. 3(b), the optical image is formed at a point 202, which is different from the point 201, on the image sensor 33.

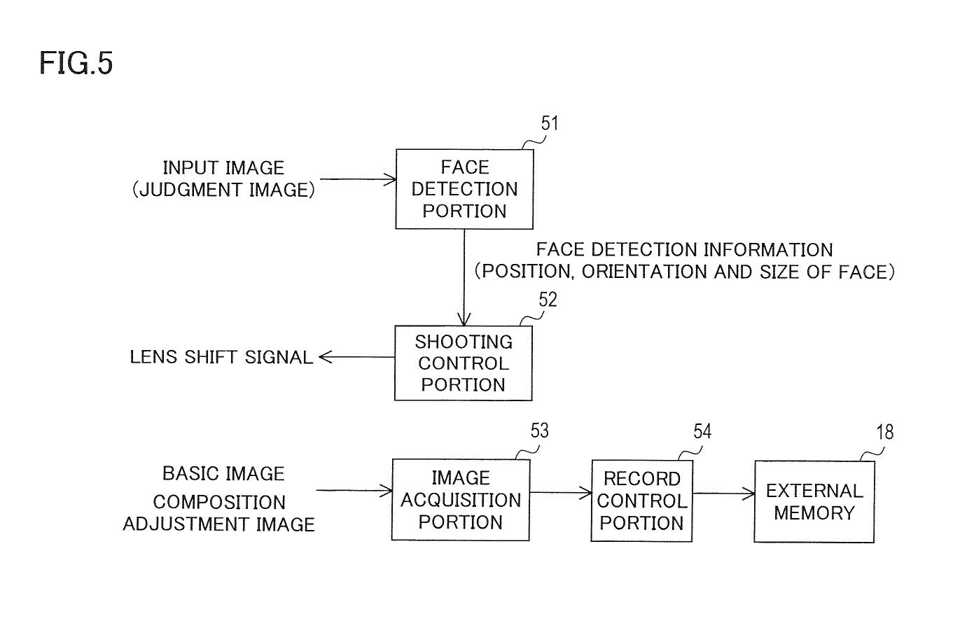

With respect to the images described in this specification, top, bottom, right and left sides are defined as shown in FIG. 4 (this definition is commonly applied to all the images). Unless otherwise stated, an image is a two-dimensional image having a rectangular contour. Suppose that a two-dimensional orthogonal coordinate plane has, as coordinate axes, X and Y axes that are orthogonal to each other, and consider a case where one of the four corners of an image is placed at the origin O on the coordinate plane. Starting from the origin O, the image is arranged along the positive directions of the X and Y axes. As viewed from a center of the image, a side toward the negative direction of the X axis is the left side, a side toward the positive direction of the X axis is the right side, a side toward the negative direction of the Y axis is the top side, and a side toward the positive direction of the Y axis is the bottom side. The left-right direction is equivalent to the horizontal direction of an image, and the top-bottom direction is equivalent to the vertical direction of the image.

In the shooting mode, the imaging device 1 is capable of performing a characteristic operation. This characteristic operation is called a composition-adjustment shooting operation. First to third composition-adjustment shooting operations will be described below one by one as examples of the composition-adjustment shooting operation. Unless inconsistent, any feature in one composition-adjustment operation is applicable to any other.

In this specification, for a simple description, the expression “image data” may be omitted in a sentence describing how some processing (such as recording, storing, reading, and the like) is performed on the image data of a given image. For example, an expression “recording of the image data of a still image” is synonymous to an expression “recording of a still image.”

[First Composition-Adjustment Shooting Operation]

First, a description will be given of a first composition-adjustment shooting operation. FIG. 5 is a partial function block diagram of the imaging device 1, showing blocks involved in the first composition-adjustment shooting operation. The functions of a face detection portion 51 and an image acquisition portion 53 are realized mainly by the video signal processing portion 13 of FIG. 1, the function of a shooting control portion 52 is realized mainly by the CPU 23 of FIG. 1, and the function of a record control portion 54 is realized mainly by the CPU 23 and the compression processing portion 16. It goes without saying that the other portions (for example, the internal memory 17) shown in FIG. 1 are also involved, as necessary, in realizing the functions of the portions denoted by reference numerals 51 to 54.

Based on image data of an input image fed thereto, the face detection portion 51 detects a human face from the input image, and extracts a face region in which the detected face is included. There have been known a variety of methods for detecting a face included in an image, and the face detection portion 51 can adopt any of them. For example, as by the method disclosed in JP-A-2000-105819, it is possible to detect a face (face region) by extracting a skin-colored region from an input image. Or, it is possible to detect a face (face region) by the method disclosed in JP-A-2006-211139 or in JP-A-2006-72770.

Typically, for example, the image in a region of interest set within an input image is compared with a reference face image having a predetermined image size, to evaluate similarity between the two images; based on the similarity, a judgment is made as to whether or not a face is included in the region of interest (whether or not the region of interest is a face region). In the input image, the region of interest is shifted one pixel at a time in the left-right or up-down direction. Then, the image in the so shifted region of interest is compared with the reference face image to evaluate similarity between the two images again, and a similar judgment is made. In this way, the region of interest is set anew every time it is shifted by one pixel, for example, from the upper left to the lower right of the input image. Moreover, the input image is reduced by a given rate, and similar face detection processing is performed with respect to the so reduced image. By repeating such processing, a face of any size can be detected from the input image.

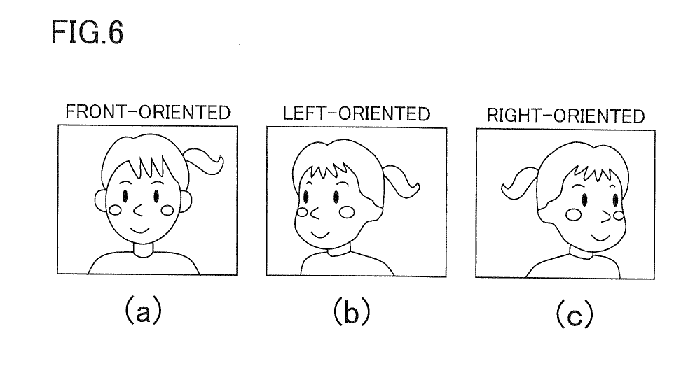

The face detection portion 51 also detects the orientation of a face in an input image. Specifically, the face detection portion 51 can distinguish and detect whether a face detected from an input image is oriented frontward, leftward, or rightward. When a face is oriented toward left or right, the orientation of the face is considered as a lateral orientation. As shown in FIG. 6(a), when a face in an image appears as a face viewed from the front, the orientation of the face is judged to be a frontward orientation. As shown in FIG. 6(b), when a face in an image appears to be looking toward the left side of the image, the orientation of the face is judged to be a leftward orientation. As shown in FIG. 6(c), when a face in an image appears to be looking toward the right side of the image, the orientation of the face is judged to be a rightward orientation. Incidentally, in an image, a face oriented frontward is oriented in a direction perpendicular both to the X and Y axes; a face oriented leftward is oriented in the negative direction of the X axis; and a face oriented rightward is oriented in the positive direction of the X axis (see FIG. 4).

Various methods have been proposed for detecting the orientation of a face, and the face detection portion 51 can adopt any of them. For example, as by the method disclosed in JP-A-H10-307923, face parts such as the eyes, nose, and mouth are found in due order from an input image to detect the position of a face in the image, and then based on projection data of the face parts, the orientation of the face is detected.

Alternatively, for example, the method disclosed in JP-A-2006-72770 may be used. In this method, a face oriented frontward is separated into two parts of a left-half part (hereinafter, left face) and a right-half part (hereinafter, right face), and through learning processing, parameter for the left face and parameter for the right face are generated in advance. When a face is detected, the region of interest within an input image is separated into left and right regions, to calculate a degree of similarity between each of the separate regions and a corresponding one of the two kinds of parameter that is mentioned above. And, when one or both of the separate regions has or have the degree or degrees of similarity higher than a threshold value, it is judged that the region of interest is a face region. Furthermore, the orientation of the face is detected based on which one of the separate regions is higher in the degree of similarity than the other.

The face detection portion 51 outputs face detection information representing a result of face detection performed by the face detection portion 51 itself. In a case where the face detection portion 51 has detected a face from an input image, the face detection information with respect to the input image specifies “the position, the orientation, and the size of the face” on the input image. In practice, for example, the face detection portion 51 extracts, as a face region, a rectangular-shaped region including a face, and shows the position and the size of the face by the position and the image size of the face region on the input image. The position of a face is, for example, the position of the center of a face region in which the face is included. Face detection information with respect to the input image is fed to the shooting control portion 52 of FIG. 5. Incidentally, in a case where no face has been detected by the face detection portion 51, no face detection information is generated or outputted, but instead, information to that effect is conveyed to the shooting control portion 52.

Based on the face detection information, the shooting control portion 52 outputs, to the driver 34 of FIG. 2, a lens shift signal for obtaining a composition adjustment image. The image acquisition portion 53 generates a basic image and a composition adjustment image from an output signal of the image sensor 33 (in other words, acquires image data of those images). Significance of basic and composition adjustment images will become clear from the descriptions given below. The record control portion 54 records the image data of the basic image and that of the composition adjustment image to the external memory 18 such that the image data of the basic image and that of the composition adjustment image are associated with each other.

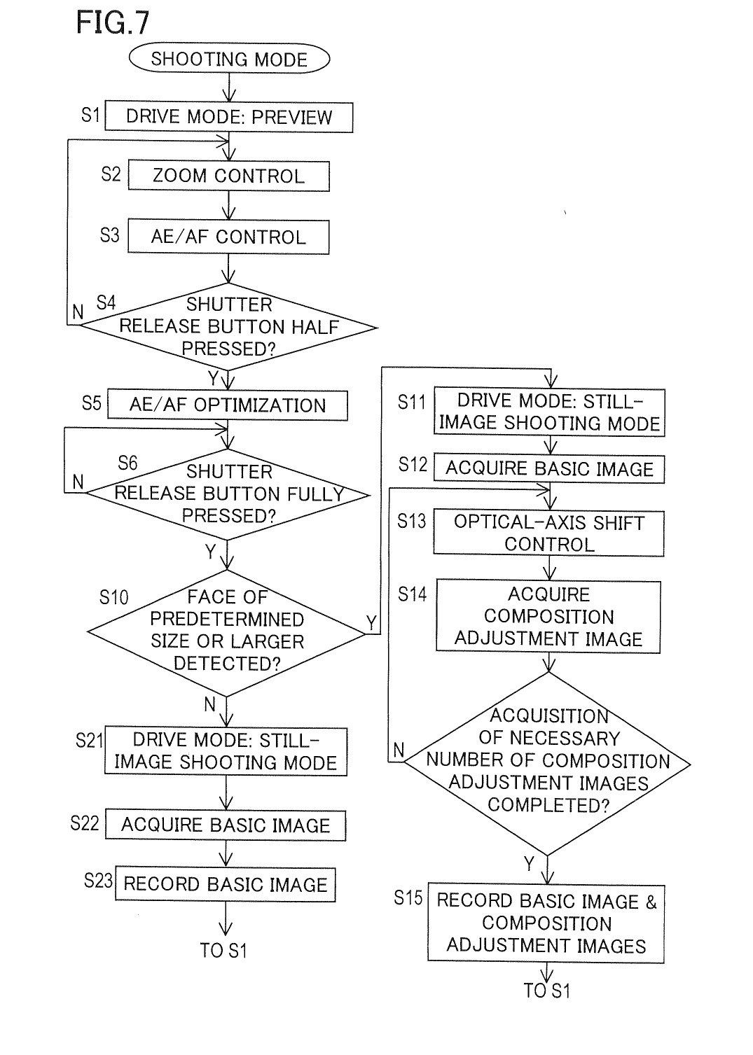

FIG. 7 is a flow chart showing the flow of the first composition-adjustment shooting operation. The first composition-adjustment shooting operation will be described according to the flow chart.

First, when the imaging device 1 is activated and brought into the shooting mode, processing of steps S1 to S6 described below is executed. That is, in step S1, the drive mode of the image sensor 33 is automatically set to a preview mode. In the preview mode, frame images are acquired from the image sensor 33 at a predetermined frame period, and the acquired series of frame images are displayed on the display portion 27 in an updated fashion. In step S2, the angle of view of the image sensing portion 11 is adjusted by driving the zoom lens 30 according to an operation performed with respect to the operation portion 26. In step S3, based on the output signal of the image sensor 33, AE (automatic exposure) control for optimizing the amount of light exposure of the image sensor 33 and AF (automatic focus) control for optimizing the focal position of the image sensing portion 11 are performed. In step S4, the CPU 23 confirms whether or not the shutter release button 26b is in a half-pressed state, and if the shutter release button 26b is found to be in a half-pressed state, the process proceeds to step S5, where the above-mentioned processing for optimizing the amount of light exposure and the focal position is performed again. Thereafter, in step S6, the CPU 23 confirms whether or not the shutter release button 26b is in a fully-pressed state, and if the shutter release button 26b is found to be in a fully-pressed state, the process proceeds to step S10.

In step S10, the shooting control portion 52 of FIG. 5 confirms whether or not a face having a predetermined size or larger has been detected from a judgment image. The judgment image here is, for example, a frame image obtained immediately after or immediately before the confirmation of the fully-pressed state of the shutter release button 26b. The face detection portion 51 receives the judgment image as an input image. Then, based on face detection information with respect to the judgment image obtained by the face detection processing, the shooting control portion 52 carries out the confirmation in step S10.

In a case where a face having the predetermined size or larger has been detected from the judgment image, the process proceeds from step S10 to step S11, where the drive mode of the image sensor 33 is set to a still-image shooting mode suitable for shooting a still image, and thereafter, processing of steps S12 to S15 is executed. In step S12, the image acquisition portion 53 acquires the basic image from the output signal of AFE 12 after the shutter release button 26b is brought into a fully-pressed state. More specifically, in step S12, the output signal of AFE 12 as it is (hereinafter, Raw data) corresponding to one frame image is temporarily written to the internal memory 17. A frame image represented by the signal written to the internal memory 17 here is the basic image. During the process from the confirmation of the fully-pressed state of the shutter release button 26b in step S6 to the acquisition of the basic image, the position of the correction lens 36 is fixed (however, shift of the correction lens 36 can be carried out to achieve optical blur correction). Thus, the basic image is an image representing a shooting range itself set by the shooter.

After the acquisition of the basic image, the process proceeds to step S13. Then, in steps S13 and S14, optical-axis shift control by the shooting control portion 52 and acquisition of a composition adjustment image by still-image shooting after the optical-axis shift control are repeatedly performed a necessary number of times. Specifically, for example, by repeating them four times, first to fourth composition adjustment images are acquired.

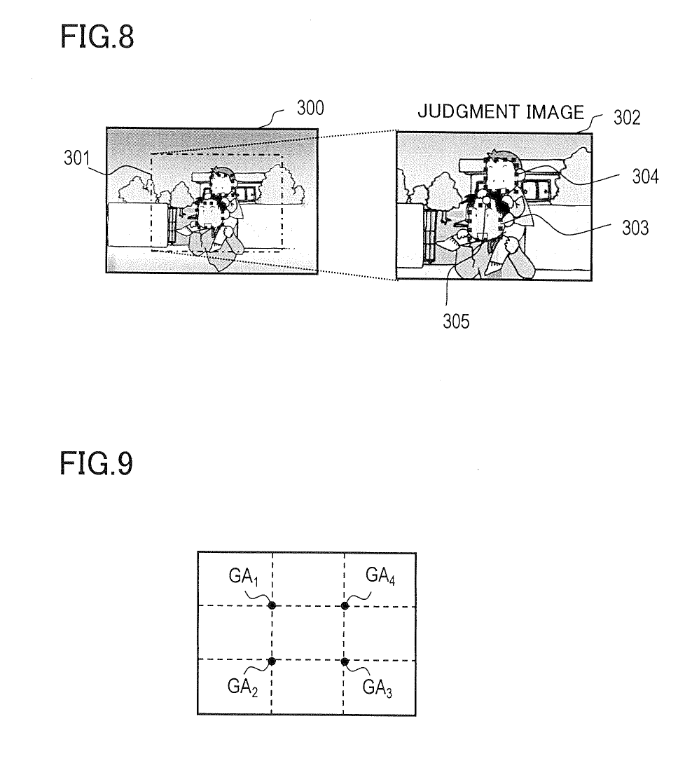

Operations performed in steps S12 to S14 will be described in detail, with reference to FIGS. 8, 9, and 10(a) to 10(e). For the sake of convenience of description, it is assumed that all the subjects to be shot by the imaging device 1 stay still in the real space, and casing of the imaging device 1 is also fixed.

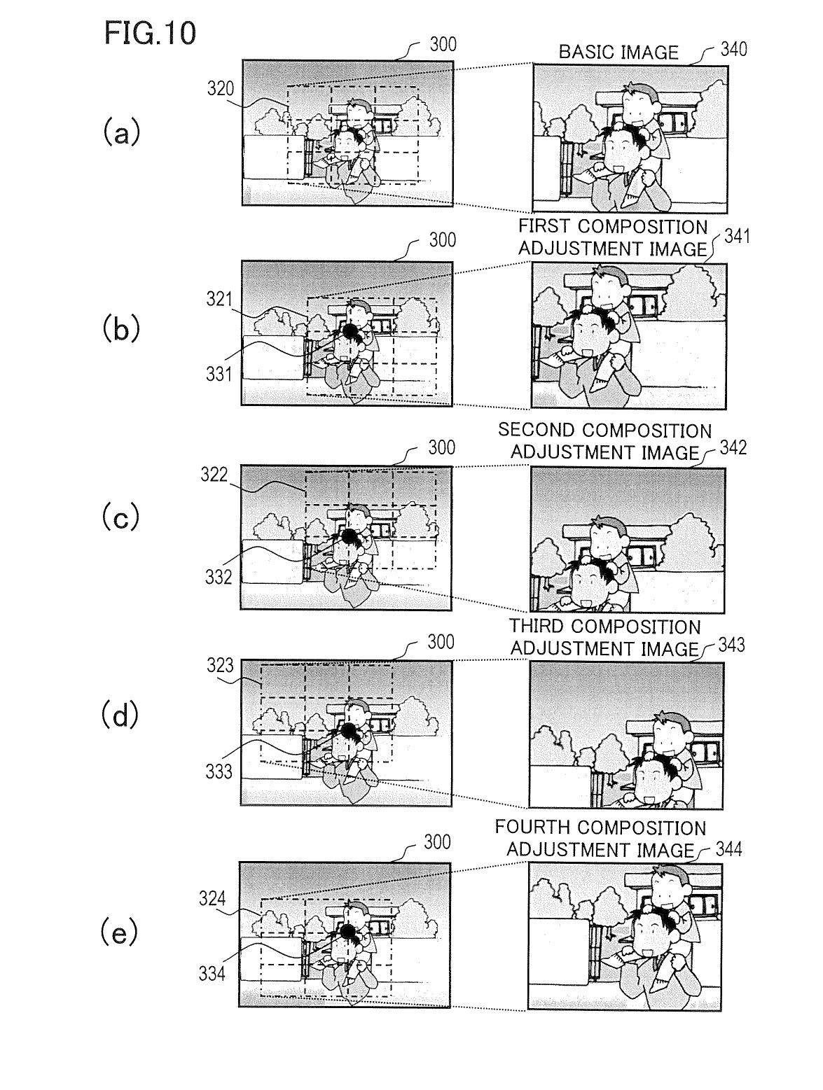

Reference numeral 300 of FIG. 8 denotes a plan view of a subject for the imaging device 1. Reference numeral 301 denotes a shooting range in shooting a judgment image, and reference numeral 302 denotes a judgment image. In FIG. 8, and in later-described FIGS. 10(a) to 10(e), FIGS. 11(a) and 11(b), and FIGS. 13(a) and 13(b), areas within rectangular regions enclosed by dash-dot lines are within a shooting range. Suppose that two face regions 303 and 304 are extracted from the judgment image 302 by the face detection portion 51. In this case, face detection information is generated with respect to each of the face regions 303 and 304. A point 305 is a midway point between the centers of the face regions 303 and 304 in the judgment image 302. The shooting control portion 52 handles the midway point as a face target point. Based on the face detection information of the face regions 303 and 304, the shooting control portion 52 detects coordinate values of the face target point. The coordinate values specify the position of the face target point on the coordinate plane of FIG. 4.

Generally, in photography shooting, it is considered preferable to locate the center of the main subject at one of intersection points of lines dividing an image into three equal parts both in the top-bottom and left-right directions. A composition having such an arrangement is called a golden-section composition. FIG. 9 shows an image of interest, two lines that divide the image into three equal parts in the top-bottom direction, two lines that divide the image into three equal parts in the left-right direction, and four intersection points GA₁ to GA₄ formed by the lines. The intersection points GA₁, GA₂, GA₃ and GA₄ are intersection points located, as viewed from the center of the image of interest, at an upper-left side, at a lower-left side, at a lower-right side, and at an upper-right side within the image of interest. Based on the coordinated values of the face target point in the judgment image, the shooting control portion 52 performs optical-axis shift control so as to locate the face target point in an “i”th composition adjustment image at an intersection point GAᵢ on the “i”th composition adjustment image (here, “i” is 1, 2, 3 or 4).

Reference numeral 340 in FIG. 10(a) denotes a basic image, and reference numerals 341 to 344 in FIGS. 10(b) to 10(e) denote first to fourth composition adjustment images, respectively. Presented to the left of FIGS. 10(a) to 10(e) are plan views 300 of the subject having, superposed thereon, a shooting range 320 for shooting the basic image, a shooting range 321 for shooting the first composition adjustment image, a shooting range 322 for shooting the second composition adjustment image, a shooting range 323 for shooting the third composition adjustment image, and a shooting range 324 for shooting the fourth composition adjustment image, respectively. In each of FIGS. 10(a) to 10(e), the two lines dividing the shooting range into three equal parts in the top-bottom direction and the two lines dividing the shooting range into three equal parts in the left-right direction are also illustrated. In each of FIGS. 10(b) to 10(e), intersection points corresponding to the intersection points GA₁ to GA₄ are denoted by reference numerals 331 to 334, respectively.

Since the position of the correction lens 36 is fixed during the process from the confirmation of the fully-pressed state of the shutter release button 26b to the acquisition of the basic image, the shooting range 320 for the shooting of the basic image 340 is equivalent to the shooting range 301 for shooting the judgment image 302, and thus, for example, with the difference in image quality being ignored, the basic image 340 and the judgment image 302 are equivalent.

On the other hand, before the shooting of the first composition adjustment image, the shooting control portion 52 performs optical-axis shift control such that the shooting range of the image sensing portion 11 coincides with the shooting range 321 of FIG. 10(b), that is, such that the face target point is located at the intersection point 331, and thereafter, Raw data representing one frame image is written to the internal memory 17. The frame image represented by the signal written to the internal memory 17 here is the first composition adjustment image. As a result, the face target point in the first composition adjustment image is located at the intersection point GA₁ on the first composition adjustment image.

After the acquisition of the first composition adjustment image, before shooting the second composition adjustment image, the shooting control portion 52 performs optical-axis shift control such that the shooting range of the image sensing portion 11 coincides with the shooting range 322 of FIG. 10(c), that is, such that the face target point is located at the intersection point 332, and thereafter, Raw data representing one frame image is written to the internal memory 17. The frame image represented by the signal written to the internal memory 17 here is the second composition adjustment image. As a result, the face target point in the second composition adjustment image is located at the intersection point GA₂ on the second composition adjustment image. Thereafter, the third and fourth composition adjustment images are acquired in the same manner. As a result, the face target point in the third composition adjustment image is located at the intersection point GA₃ on the third composition adjustment image, and the face target point in the fourth composition adjustment image is located at the intersection point G₄ on the fourth composition adjustment image.

After the first to fourth composition adjustment images are acquired in the above-described manner, the process proceeds to step S15 (see FIG. 7). In step S15, the record control portion 54 of FIG. 5 records the image data of those images to the external memory 18 such that the image data of those images are associated with each other. Then, the process returns to step S1. Image data is expressed by a video signal of a YUV format. More specifically, the record control portion 54 reads the Raw data of the basic image and of the first to fourth composition adjustment images temporarily recorded on the internal memory 17, and JPEG-compresses the video signals (YUV signals) representing those images obtained from the Raw data. Then, the record control portion 54 records the compressed signals to the external memory 18 such that they are associated with each other. The JPEG-compression is signal compression processing according to the standard of JPEG (Joint Photographic Experts Group). Incidentally, it is possible to record Raw data to the external memory 18 as it is, without JPEG-compressing the Raw data.

In a case where no face of the predetermined size or larger has been detected from the judgment image in step S10, the process proceeds from step S10 to step S21, and the drive mode of the image sensor 33 is set to the still-image shooting mode suitable for shooting a still image, and thereafter, processing of steps S22 and S23 is executed. The processing performed in step S22 is equivalent to that performed in step S12, and thereby a basic image is acquired. Image data of this basic image is recorded to the external memory 18 in step S23, and thereafter, the process returns to step S1.

By the processing described above, an image having a golden-section composition is automatically recorded simply in response to a still-image shooting instruction, and this makes it possible to provide a user with a highly artistic image.

Incidentally, in contrast to the above-discussed example, which deals with a case where a plurality of faces are detected from a judgment image, in a case where only one face is detected from a judgment image, the center of a face region including the detected face may be handled as the face target point (this also applies to later-described second and third composition-adjustment shooting operations and an automatic-trimming playback operation).

In a case where a plurality of faces are detected from a judgment image, sizes of the faces may be acquired from the face detection information of a judgment image to find the largest face, which is to be considered as the face of a main subject, and the center of a face region including the face of the main subject may be handled as the face target point (this also applies to later-described second and third composition-adjustment shooting operations and an automatic-trimming playback operation).

Also, in the above-discussed example, the basic image is shot after the judgment image. This means that, although the judgment image and the basic image are different from each other, one frame image can be used both as the judgment image and the basic image. In this case, after the fully-pressed state of the shutter release button 26b is confirmed, a frame image is acquired in a still-image shooting mode, and the frame image is handled both as a basic image and a judgment image. And, in a case where a face of a predetermined size or larger is detected from the judgment image, the processing of the above-described steps S13 to S15 is performed, and in a case where no such face is detected, the processing of the above-described step S23 is performed.

[Second Composition-Adjustment Shooting Operation]

Next, a description will be given of a second composition-adjustment shooting operation. In the first composition-adjustment shooting operation, when the process reaches step S11 from step S10 shown in FIG. 7, four composition adjustment images are acquired and recorded, but in the second composition-adjustment shooting operation, by taking the orientation of a face into consideration, the number of composition adjustment images to be acquired and recorded is reduced to not more than three. The second composition-adjustment shooting operation results from modifying part of the first composition-adjustment shooting operation, and unless otherwise stated, operations and features of the second composition-adjustment shooting operation are equivalent to those of the first composition-adjustment shooting operation. Hereinafter, it is assumed that a face of a predetermined size or larger is detected from a judgment image.

In the second composition-adjustment shooting operation as well, in a case where a face of the predetermined size or larger is detected from a judgment image in step S10 after the processing of steps S1 to S6 of FIG. 7, shooting of a basic image is first performed (steps S11 and S12), and thereafter, the process proceeds to step S13. In steps S13 and S14, optical-axis shift control by the shooting control portion 52 and acquisition of a composition adjustment image by shooting a still image after the optical-axis shift control are repeatedly performed a necessary number of times. The shooting control portion 52 determines the number of times and the composition adjustment image to be acquired according to the orientation of the face in the judgment image.

Generally, in photography shooting, it is thought that a good composition is one in which there is a wider space on the side toward which a face is oriented. Accordingly, after the shooting of the basic image, optical-axis shift control is performed such that only an image having such a composition is acquired.

Specifically, first, the shooting control portion 52 specifies, from the face detection information of the judgment image, whether the face within the judgment image is oriented frontward, leftward or rightward. The orientation of the face specified here is called a “face-of-interest orientation”. In a case where a plurality of faces are detected from the judgment image, sizes of the faces are acquired from the face detection information of the judgment image to find the largest face, which is to be considered as the face of a main subject, and the orientation of the face of the main subject is handled as the face-of-interest orientation.

In a case where the face-of-interest orientation is a frontward orientation, in a manner similar to that of the first composition-adjustment shooting operation, first to fourth composition adjustment images are acquired and recorded. On the other hand, in a case where the face-of-interest orientation is a leftward orientation, based on the coordinate values of the face target point in the judgment image (in the case of the example in FIG. 8, the point 305), the shooting control portion 52 performs optical-axis shift control such that either one of the following is acquired: a composition adjustment image in which the face target point is located at the intersection point GA₃ or a composition adjustment image in which the face target point is located at the intersection point GA₄ (see FIG. 9). In a case where the face-of-interest orientation is a rightward orientation, based on the coordinate values of the face target point in the judgment image, the shooting control portion 52 performs optical-axis shift control such that either one of the following is acquired: a composition adjustment image in which the face target point is located at the intersection point GA₁ or a composition adjustment image in which the face target point is located at the intersection point GA₂.

Specific examples will be given below. Now, suppose that the subject is the same as shown in the first composition-adjustment shooting operation, and consider a case where the judgment image is the judgment image 302 of FIG. 8, from which two face regions 303 and 304 are extracted. Suppose, also, that the size of the face corresponding to the face region 303 is larger than that of the face corresponding to the face region 304, and the orientation of the face corresponding to the face region 303 (that is, the face-of-interest orientation) is a leftward orientation.

Then, the shooting control portion 52 performs optical-axis shift control so as to acquire either one of the following: a composition adjustment image in which the face target point is located at the intersection point GA₃ or a composition adjustment image in which the face target point is located at the intersection point GA₄. Also, here, a description will be given of a case, as an example, where the largest face is regarded as the face of the main subject, and the center of the face region that includes the face of the main subject is handled as the face target point.

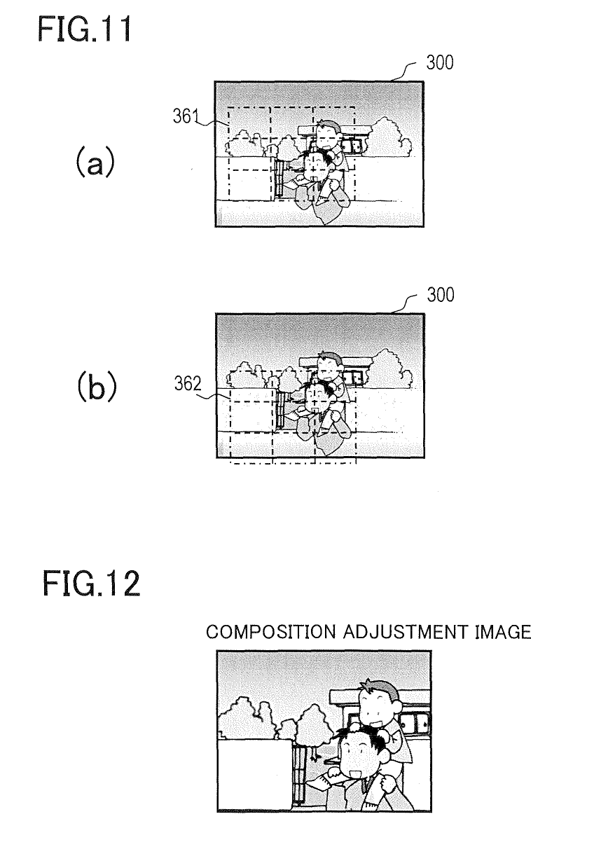

Based on the positional relationship between the face regions 303 and 304, the shooting control portion 52 judges which of the following will have a better composition: the composition adjustment image in which the face target point is located at the intersection point GA₃ or the composition adjustment image in which the face target point is located at the intersection point GA₄. Here, the sizes of the faces can also be considered. FIGS. 11(a) and 11(b) are diagrams showing a shooting range 361 for acquiring the former composition adjustment image and a shooting range 362 for acquiring the latter composition adjustment image, respectively, superposed on the plan view 300 of the subject. In the example under discussion, where the face region 304 is located above the face region 303, if the shooting range 362 is used, the face region 304 is located too close to an upper edge of the shooting range, and part of the face or the head part corresponding to the face region 304 may disadvantageously protrude from the shooting range. Thus, the shooting control portion 52 judges that the composition adjustment image in which the face target point is located at the intersection point GA₃ has a better composition, and acquires the composition adjustment image.

That is, in the example under discussion, before shooting the composition adjustment image after the basic image is acquired, based on the coordinate values of the face target point of the judgment image, optical-axis shift control is performed such that the shooting range of the image sensing portion 11 is equivalent to the shooting range 361 of FIG. 11(a), and thereafter, Raw data representing one frame image is written to the internal memory 17. The frame image represented by the signal written to the internal memory 17 here is one composition adjustment image to be acquired in step S14. The face target point in this composition adjustment image is located at the intersection point GA₃ on the composition adjustment image. The thus acquired composition adjustment image is shown in FIG. 12.

Then, the process proceeds to step S15, where the record control portion 54 of FIG. 5 records the image data of the basic image obtained in step S12 and the image data of the composition adjustment image obtained in step S14 (that is, two pieces of image data representing a total of two images) to the external memory 18 such that they are associated with each other. Thereafter, the process returns to step S1. The specific method of this recording is as shown in the first composition-adjustment shooting operation.

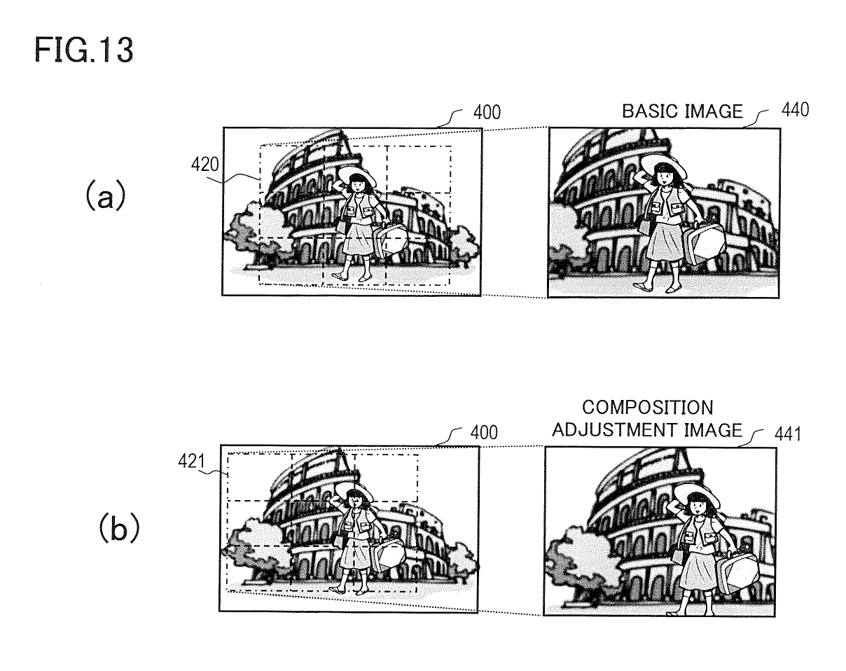

Another example will be explained with reference to FIGS. 13(a) and 13(b). In FIG. 13(a), reference numeral 400 denotes a plan view of a subject for the imaging device 1, reference numeral 420 denotes a shooting range for shooting a judgment image and a basic image, and reference numeral 440 denotes a basic image acquired in step S12. In this case, since one face region is extracted from the judgment image, the center of the face region is handled as the face target point. As shown in FIG. 13(a), the orientation of the face in the extracted face region is a leftward orientation. Thus, after the basic image is acquired, based on the fact that the face is oriented leftward, the shooting control portion 52 performs optical-axis shift control so as to acquire either one of the following: a composition adjustment image in which the face target point is located at the intersection point GA₃ or a composition adjustment image in which the face target point is located at the intersection point GA₄.

Based on the position of the face region, the shooting control portion 52 judges which of the following will have a better composition: the composition adjustment image in which the face target point is located at the intersection point GA₃ or the composition adjustment image in which the face target point is located at the intersection point GA₄. Here, the size of the face can also be considered. In the case shown in FIG. 13(a), where there is only one person as a subject, it can be said that a composition having the entire image of the person within the shooting range is better than otherwise. Thus, the shooting control portion 52, based on the face detection result, estimates the position of the person's body, and judges a composition having more of the body within the shooting range as a better composition. In the example shown in FIG. 13(a), the body is located in the lower side of the image with respect to the face, the shooting control portion 52 acquires a composition adjustment image in which the face target point is located at the intersection point GA₄. In FIG. 13(b), a shooting range 421 for acquiring such a composition adjustment image and the acquired composition adjustment image 441 are shown. Then, image data representing a total of two images, namely the basic image and the composition adjustment image, is recorded to the external memory 18 such that they are associated with each other, and this concludes the shooting operation.

In the example corresponding to FIG. 13(a), in a case where the face is comparatively large, the composition adjustment image where the face target point is located at the intersection point GA₃ may be acquired instead of the composition adjustment image where the face target point is located at the intersection point GA₄.

The above-described processing makes it possible to achieve the same advantage as the first composition-adjustment shooting operation. Furthermore, a composition adjustment image having a better composition (that is, the best composition adjustment image) is selectively acquired and recorded according to the face orientation, and this helps reduce the necessary processing time and the necessary storage capacity in comparison with the first composition-adjustment shooting operation.

Incidentally, in the example described above, in a case where the face is laterally oriented, only one composition adjustment image is acquired, but two or three composition adjustment images may be acquired instead. For example, in the example corresponding to FIG. 11(a), or in the example corresponding to FIG. 13(a), after the basic image is acquired, optical-axis shift control and still-image shooting after the optical-axis shift control may be repeated twice to acquire both a composition adjustment image where the face target point is located at the intersection point GA₃ and a composition adjustment image where the face target point is located at the intersection point GA₄. In this case, image data representing two composition adjustment images and image data representing the basic image are recorded to the external memory 18 such that they are associated with each other.

[Third Composition-Adjustment Shooting Operation]

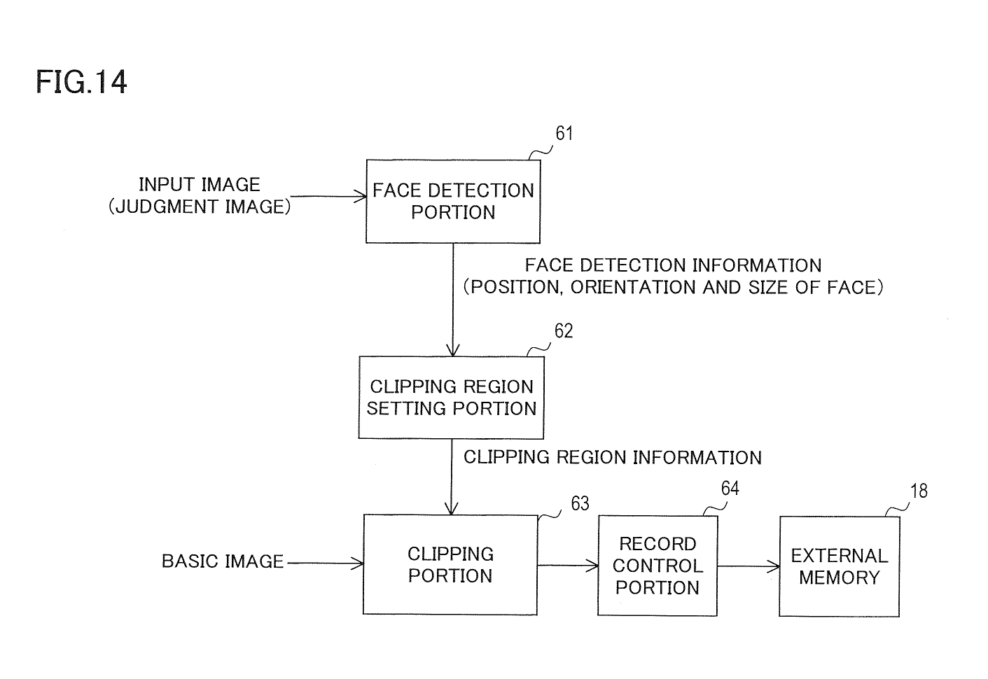

Next, a description will be given of a third composition-adjustment shooting operation. In the third composition-adjustment shooting operation, a composition adjustment image is acquired not by using optical-axis shift control but by using image clipping processing. FIG. 14 is a partial function block diagram of the imaging device 1, showing blocks involved in the third composition-adjustment shooting operation. The functions of a face detection portion 61 and a clipping portion 63 are mainly realized by the video signal processing portion 13 of FIG. 1, the function of a clipping region setting portion 62 is mainly realized by the CPU 23 (and/or the video signal processing portion 13) of FIG. 1, and the function of a record control portion 64 is mainly realized by the CPU 23 and the compression control portion 16. It goes without saying that the other portions (for example, the internal memory 17) shown in FIG. 1 are also involved, as necessary, in realizing the functions of the portions denoted by reference numerals 61 to 64.

The face detection portion 61 has the same function as the face detection portion 51 (see FIG. 5) shown in the first composition-adjustment shooting operation, and conveys face detection information with respect to an input image (judgment image) to the clipping region setting portion 62. Image data of a basic image having a composition specified by a shooter is fed to the clipping portion 63. Based on the face detection information, the clipping region setting portion 62 sets a region for cutting out a composition adjustment image from the basic image, and conveys, to the clipping portion 63, clipping region information that specifies the position and the size of the clipping region on the basic image. The clipping portion 63 cuts out a partial image of the basic image according to the clipping region information, and generates the image resulting from the cutting (hereinafter, a clipped image) as a composition adjustment image. The record control portion 64 records image data of the generated composition adjustment image and image data of the basic image to the external memory 18 such that they are associated with each other.

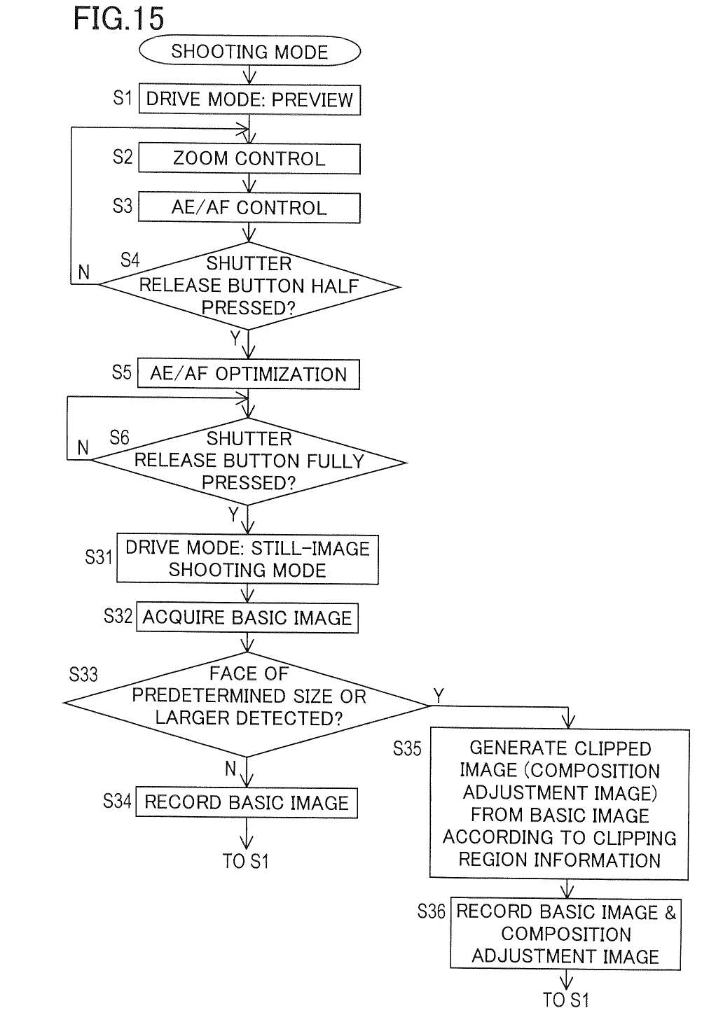

FIG. 15 is a flow chart showing the flow of the third composition-adjustment shooting operation. The third composition-adjustment shooting operation will be described according to the flow chart. During the operation, the position of the correction lens 36 remains fixed (however, shift of the correction lens 36 can be carried out to achieve optical blur correction).

First, when the imaging device 1 is activated, processing of steps S1 to S6 described below is executed. The processing of steps S1 to S6 is the same as in the first composition-adjustment shooting operation (see FIG. 7). If, however, it is confirmed that the shutter release button 26b is in the fully-pressed state in step S6, the process proceeds to step S31, where the drive mode of the image sensor 33 is set to the still-image shooting mode suitable for shooting a still image. Then, in the next step S32, the clipping portion 63 acquires a basic image from the output signal of AFE 12 after the confirmation of the fully-pressed state of the shutter release button 26b. More specifically, in step S32, Raw data representing one frame image is temporarily written to the internal memory 17. A frame image represented by the signal written to the internal memory 17 here is the basic image. The basic image is an image of a shooting range itself set by the shooter.

Thereafter, in step S33, based on the face detection information of a judgment image fed from the face detection portion 61, the clipping region setting portion 62 confirms whether or not a face of a predetermined size or larger has been detected from the judgment image. In this example, the basic image is also used as the judgment image. However, it is possible to generate the judgment image independently of the basic image. For example, it is possible to handle, as the judgment image, a frame image obtained by shooting performed immediately before or a several frames before the shooting of the basic image, or a frame image obtained by shooting performed immediately after or a several frames after the shooting of the basic image.

And, in a case where no face of a predetermined size or larger has been detected from the judgment image, the process proceeds from step S33 to step S34, where the image data of the basic image is recorded to the external memory 18, and then the process returns to step S1.

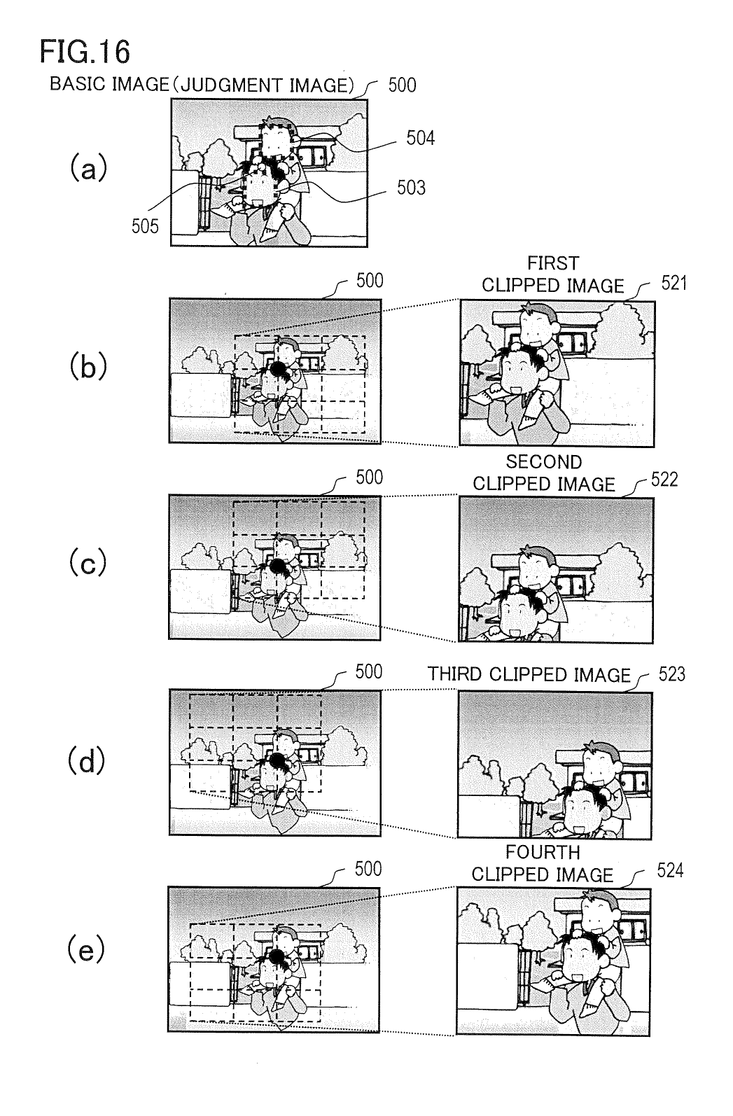

On the other hand, in a case where a face of a predetermined size or larger has been detected from the judgment image, the process proceeds from step S33 to step S35, and the processing of steps S35 and S36 is executed. In step S35, one or more clipped images are cut out from the basic image. Referring to FIGS. 16(a) to 16(e), a description will be given of what is done in the processing of step S35.

In FIG. 16(a), an image denoted by reference numeral 500 is the basic image acquired in step S32. The face detection portion 61 executes face-detection processing, handling the basic image 500 as the judgment image, to thereby generate face detection information of the judgment image. Suppose that two face regions 503 and 504 are extracted from the judgment image by the face detection portion 61. In this case, face detection information is generated for each of the face regions 503 and 504. A point 505 is a midway point between the centers of the face regions 503 and 504 in the judgment image. The clipping region setting portion 62 handles this midway point as a face target point. Based on the face detection information of the face regions 503 and 504, the clipping region setting portion 62 detects coordinate values of the face target point. The coordinate values specify the position of the face target point on the coordinate plane of FIG. 4.

Based on the coordinate values of the face target point in the judgment image, the clipping region setting portion 62 sets a clipping position and a clipping size such that all or part of first to fourth clipped images 521 to 524 shown in FIGS. 16(b) to 16(e), respectively, are cut out from the basic image 500, and sends clipping region information indicating the set clipping positions and the set clipping sizes to the clipping portion 63. Here, the clipping region setting portion 62 generates the clipping region information such that the face target point in the “i”th clipped image is located at the intersection point GAᵢ on the “i”th clipped image (here, “i”=1, 2, 3 or 4) (see FIG. 9). Furthermore, the clipping region setting portion 62 generates the clipping region information such that a clipped image has as large an image size as possible. According to the clipping region information, the clipping portion 63 generates all or part of the first to fourth clipped images 521 to 524 from the basic image 500. The first to fourth clipped images are handled as first to fourth composition adjustment images, respectively.

After the basic image and one or more composition adjustment ages are acquired in the above-described manner, the process proceeds from step S35 to step S36 (see FIG. 15). In step S36, the record control portion 64 of FIG. 14 records the image data of the basic image obtained in step S32 and the image data of the one or more composition adjustment images obtained in step S35 to the external memory 18 such that they are associated with each other; thereafter, the process returns to step S1. Here, image data for up to five images is recorded to the external memory 18.

More specifically, Raw data of the basic image temporarily recorded in the internal memory 17 is read, and video signals (YUV signals) of the basic image and the composition adjustment images are generated from the Raw data. Thereafter, the video signals are JPEG-compressed and recorded to the external memory 18. The video signals can also be recorded without being JPEG-compressed.

A composition adjustment image is a partial image of a basic image, and thus, of a composition adjustment image and a basic image, which are recorded, the former has a smaller image size (that is, a smaller number of pixels arranged in the horizontal and vertical directions) than the latter. However, interpolation processing may be used to increase the image size of a composition adjustment image to eliminate the difference in image size between basic and composition adjustment images, and image data (video signal) of the composition adjustment image may be recorded to the external memory 18 after its image size is increased.

Which of the clipped images 521 to 524 to choose as a composition adjustment image to be generated and recorded is determined by the method shown in the second composition-adjustment shooting operation. That is, according to the method described in the second composition-adjustment shooting operation, the face-of-interest orientation is detected based on the face detection information of the judgment image. Then, in a case where the face-of-interest orientation is a frontward orientation, the clipped images 521 to 524 are all generated and recorded.

On the other hand, in a case where the face-of-interest orientation is a leftward orientation, either the clipped image 523 or 524 is generated and recorded. That is, according to the method described in the second composition-adjustment shooting operation, based on the number of faces in the judgment image, and based on the position, orientation and size of a face in the judgment image, it is judged which one of the clipped images 523 and 524 has a better composition than the other, and the clipping image that is judged to have a better composition is generated and recorded. However, both the clipped images 523 and 524 may be generated and recorded.

On the other hand, in a case where the face-of-interest orientation is a rightward orientation, either the clipped image 521 or the clipped image 522 is generated and recorded. That is, according to the method described in the second composition-adjustment shooting operation, based on the number of faces in the judgment image, and based on the position, orientation and size of a face in the judgment image, it is judged which one of the clipped images 521 and 522 has a better composition than the other, and the clipping image that is judged to have a better composition is generated and recorded. However, both the clipped images 521 and 522 may be generated and recorded.

By executing the above-described processing, an image having a golden-section composition is automatically recorded simply in response to a still-image shooting instruction, and this makes it possible to offer a highly artistic image to the user. In addition, by selecting, according to the orientation of a face, a composition adjustment image to be recorded, it is possible to reduce necessary processing time and necessary storage capacity.

[Recording Format]

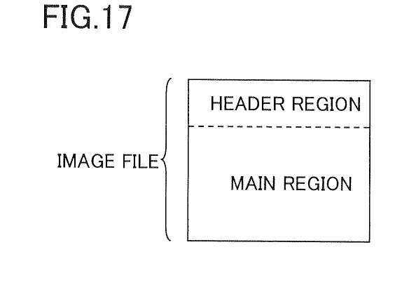

Next, a description will be given of a recording format for an image data to be recorded by using any one of the first to third composition-adjustment shooting operations. A basic image and one or more composition adjustment images obtained in connection with the basic image are stored in an image file and recorded in the external memory 18. FIG. 17 shows the structure of an image file. The image file is composed of a main region and a header region. In the header region, there is stored additional information (the focal length in shooting, the shooting date, etc.) with respect to a corresponding image. In a case where the file format of the image file is based on the Exif (exchangeable image file format), the header region is also called an Exif tag or an Exif region. The file format for the image file can be based on any standard. Incidentally, in the following descriptions, unless otherwise stated, an image file refers to an image file recorded within the external memory 18. Generation and recording of an image file is performed by the record control portion 54 of FIG. 5 or by the record control portion 64 of FIG. 14.

For the sake of concrete description, the following description deals with a case where a basic image and first to fourth composition adjustment images are acquired and recorded to the external memory 18 such that they are associated with each other by the shooting and recording operations described in the first composition-adjustment shooting operation. In the following descriptions, “five images” refers to the basic image and the first to fourth composition adjustment images.

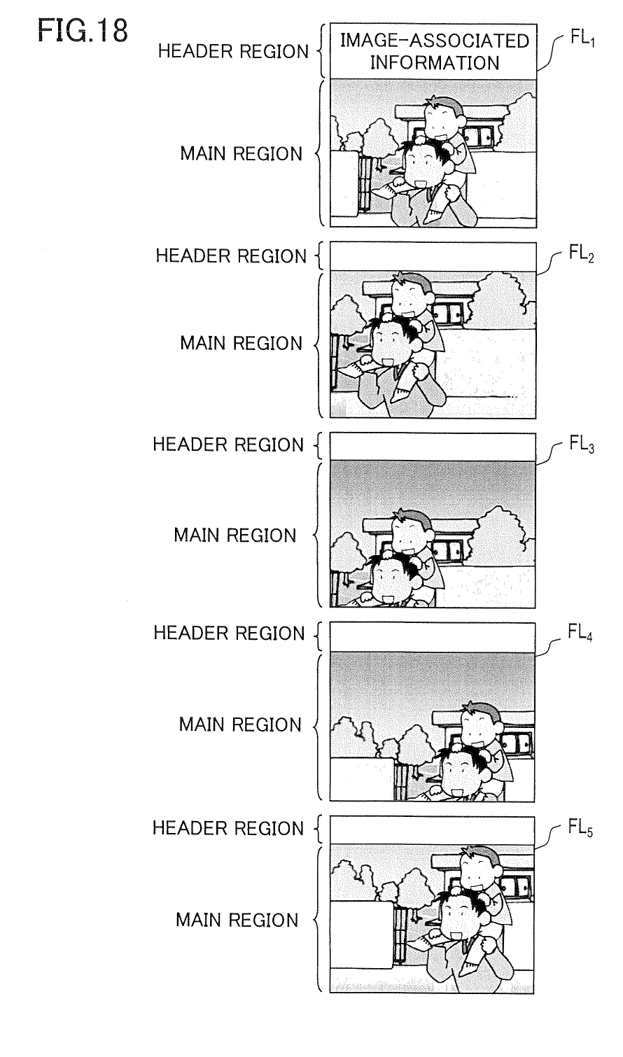

First, with reference to FIG. 18, a description will be given of a first recording format that is adoptable. In a case where the first recording format is adopted, five image files FL₁ to FL₅ for independently storing the five images are generated and recorded to the external memory 18. The image data of the basic image is stored in the main region of the image file FL₁, and the image data of the first to fourth composition adjustment images are stored in the main regions of the image files FL₂to FL₅, respectively. And, only in the header region of the image file FL_{’}, image-associated information is stored. The image-associated information is information for specifying the image files FL₂ to FL₅, and it is by this information that the image file FL₁ is associated with the image files FL₂ to FL₅.

Ordinarily, in the playback mode, the user is only allowed to view the basic image, and only when a special operation is applied to the imaging device 1, the user is allowed to view the first to fourth composition adjustment images which are played back on the display portion 27. In viewing the composition adjustment images, by applying a predetermined operation to the imaging device 1, the user can collectively delete all of, or separately delete part of, the image files FL₂ to FL₅ from the external memory 18. The image files FL₁ to FL₅ may be integrally managed as a single group of associated files, and file operations for the image file FL₁ may be applied to all the image files FL₁ to FL₅ as well. File operations include operations for instructing deletion of an image file, alteration of file name, and the like. Incidentally, operation in the playback mode, which is described above, is also applied to an image playback device (not shown) different from the imaging device 1, when it receives data recorded in the external memory 18.

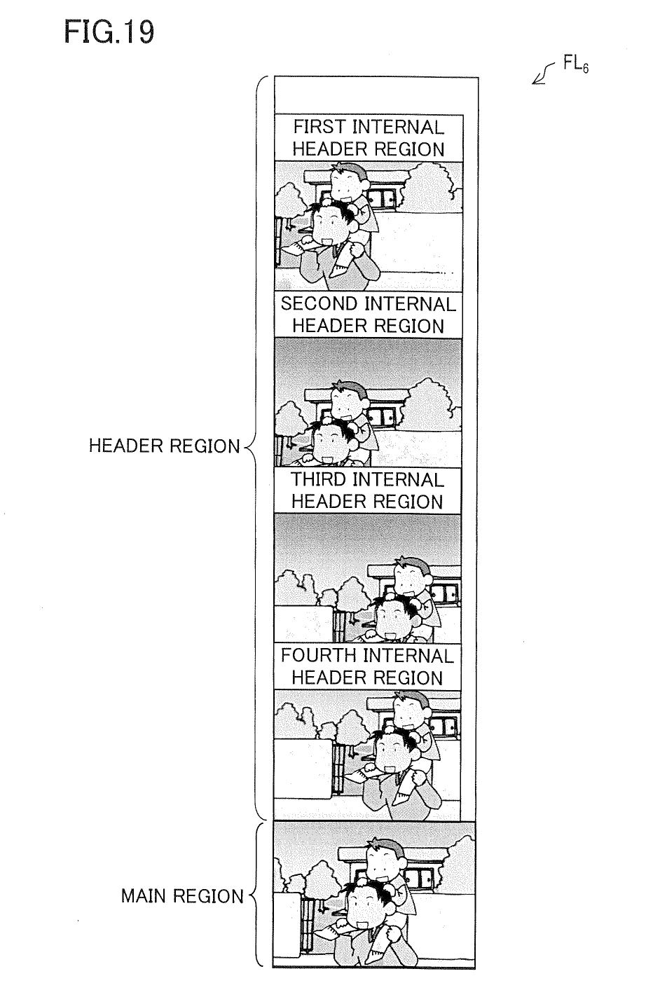

Next, with reference to FIG. 19, a description will be given of a second recording format that is adoptable. In a case where the second recording format is adopted, only one image file FL₆ is generated and recorded to the external memory 18. The image data of the basic image is stored in the main region of the image file FL₆, and the image data of the first to fourth composition adjustment images are stored in a header region of the image file FL₆, to thereby associate the five images with each other. In addition, within the header region of the image file FL₆, first to fourth internal header regions are provided corresponding to the first to fourth composition adjustment images, respectively.

Ordinarily, in the playback mode, the user is only allowed to view the basic image, and only when a special operation is applied to the imaging device 1, the user is allowed to view the first to fourth composition adjustment images which are played back on the display portion 27. In viewing the composition adjustment images, by applying a predetermined operation to the imaging device 1, the user can collectively delete all of, or separately delete part of, the first to fourth composition adjustment images from the image file FL₆. It is possible to extract a composition adjustment image that the user likes in another image file by a predetermined operation (that is, it is possible to store a specified composition adjustment image in an image file other than the image file FL₆). If an instruction is given to delete the image file FL₆ from the external memory 18, the five images are naturally all deleted from the external memory 18. Incidentally, the operation in the playback mode described above is also applied to another image playback device (not shown) which is different from the imaging device 1, when it receives data recorded in the external memory 18.

The recording format dealt with in the above description is for recording the basic image and the four composition adjustment images such that they are associated with each other, but the recording format is also applicable to a case where the number of composition adjustment images is three or less.

[Automatic-Trimming Playback Operation]

Next, a description will be given of a characteristic playback operation that the imaging device 1 can perform in the playback mode. This playback operation is called an automatic-trimming playback operation. In the automatic-trimming playback operation, a composition adjustment image is cut out from an input image fed from the external memory 18 or from outside the imaging device 1, and the composition adjustment image is played back and displayed. In the following description, a composition adjustment image is displayed on the display portion 27 provided in the imaging device 1, but a composition adjustment image may be displayed on an external display device (not shown) that is provided outside the imaging device 1.

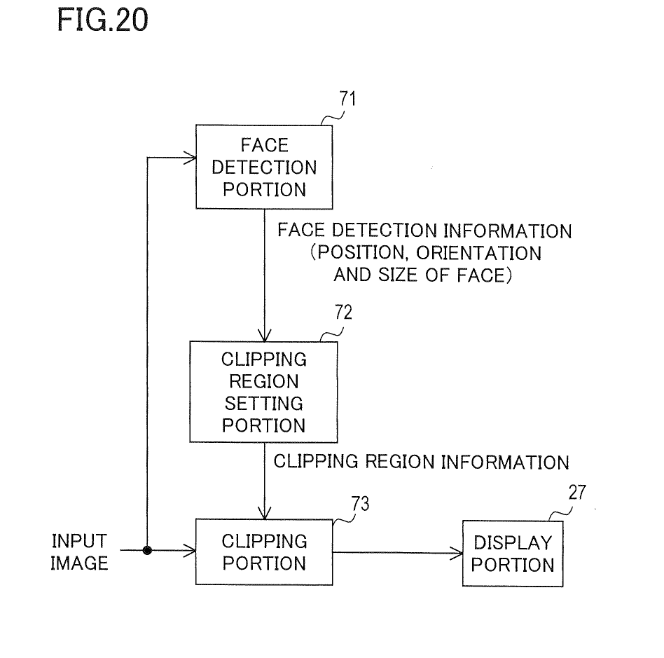

FIG. 20 is a partial function block diagram showing, in connection with an automatic-trimming playback operation, the imaging device of FIG. 1. A face detection portion 71, a clipping region setting portion 72, and a clipping portion 73 have the same function as the face detection portion 61, the clipping region setting portion 62, and the clipping portion 63, respectively, of FIG. 14, and the face detection portion 61, the clipping region setting portion 62, and the clipping portion 63 may also be used, as they are, as the face detection portion 71, the clipping region setting portion 72, and the clipping portion 73, respectively.

To the face detection portion 71 and the clipping portion 73, image data of an input image is fed from the external memory 18 or from outside the imaging device 1. In the following description, it is assumed that image data of an input image is fed from the external memory 18. This input image is, for example, an image that has been shot and recorded with none of the above-described composition-adjustment shooting operations performed thereon.

The face detection portion 71 conveys face detection information with respect to the input image to the clipping region setting portion 72. Based on the face detection information, the clipping region setting portion 72 sets a clipping region to cut out a composition adjustment image from the input image, and conveys, to the clipping portion 73, clipping region information specifying the position and the size of the clipping region on the input image. The clipping portion 73 cuts out a partial image of the input image according to the clipping region information, and generates a clipped image as a composition adjustment image. This composition adjustment image generated as a clipped image is played back and displayed on the display portion 27.

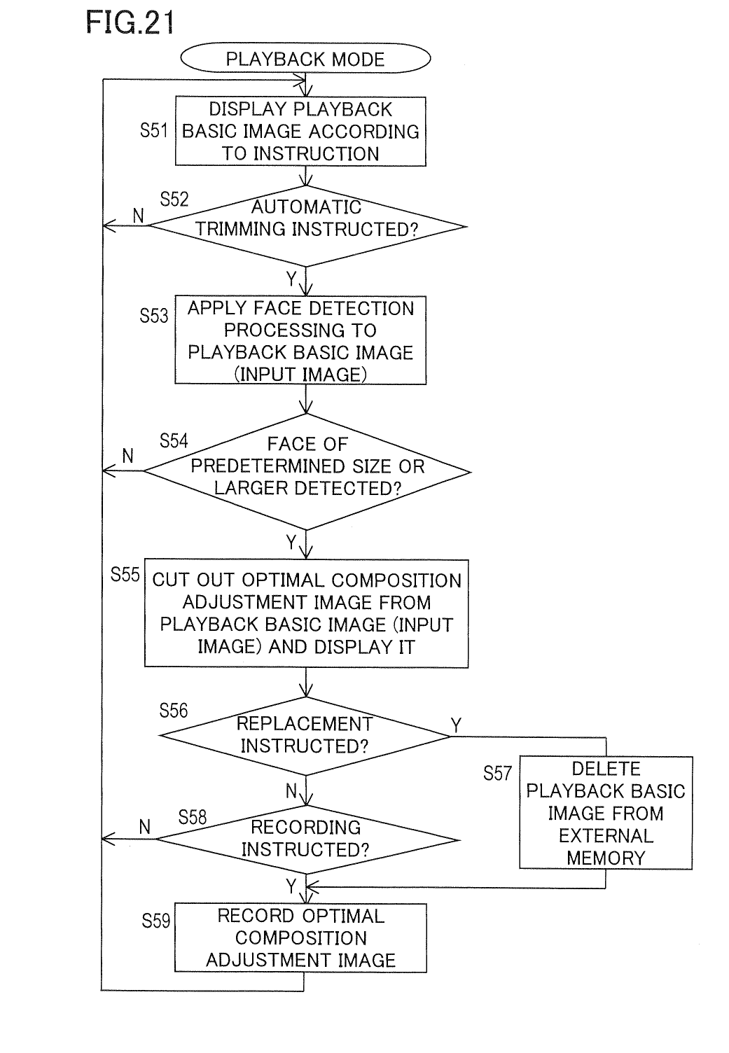

FIG. 21 is a flow chart showing the flow of the automatic-trimming playback operation. The automatic-trimming playback operation will be described according to this flow chart. Later-described various instructions (such as an automatic-trimming instruction) for the imaging device 1 are given to the imaging device 1, for example, by operating the operation portion 26, and the CPU 23 judges whether or not an instruction has been received.

First, when the imaging device 1 is activated and the operation mode of the imaging device 1 is brought into the playback mode, in step S51, a still image which is recorded in the external memory 18 and in accordance with the user's instruction is played back and displayed on the display portion 27. The still image here is called a playback basic image. If the user gives an automatic-trimming instruction with respect to the playback basic image, the process proceeds to step S53 via step S52. If no automatic-trimming instruction is given, the processing of step S51 is repeated.

In step S53, the playback basic image in step S51 is given as an input image to the face detection portion 71 and the clipping portion 73, and the face detection portion 71 executes face detection processing with respect to the playback display image to generate face detection information. Based on the face detection information, in the following step S54, the clipping region setting portion 72 confirms whether or not a face of a predetermined size or larger has been detected from the playback basic image. If a face of the predetermined size or larger has been detected, the process proceeds to step S55, while the process returns to step S51 if no face of the predetermined size or larger has been detected.

In step S55, by the clipping region setting portion 72 and the clipping portion 73, one optimal composition adjustment image is cut out from the playback basic image to be displayed. The clipping region setting portion 72 and the clipping portion 73 generates one composition adjustment image from the playback basic image by using the same method that is described in the third composition-adjustment shooting operation as a method for generating one composition adjustment image from a basic image.

Here, for example, think of a case where the playback basic image in step S51 is the same as the basic image 500 shown in FIG. 16(a). In this case, face detection information is generated for each of the face regions 503 and 504. Handling the midway point 505 between the centers of the face regions 503 and 504 in the playback basic image as a face target point, the clipping region setting portion 72 detects coordinate values of the face target point based on the face detection information of the face regions 503 and 504. The coordinate values specify the position of the face target point on the coordinate plane of FIG. 4. It is also possible to handle, as a face target point, the center point of whichever one of the face regions 503 and 504 corresponds to the larger face.

Based on the coordinate values of the face target point in the playback basic image, the clipping region setting portion 72 sets a clipping position and a clipping size such that any one of the first to fourth clipped images 521 to 524 shown in FIGS. 16(b) to 16(e), respectively, is cut out from the playback basic image, and sends clipping region information indicating the set clipping position and the set clipping size to the clipping portion 73. Here, the clipping region setting portion 72 generates clipping region information such that the face target point in the “i”th clipped image is located at the intersection point GAᵢ on the “i”th clipped image (here, “i”=1, 2, 3 or 4) (see FIG. 9). Furthermore, the clipping region setting portion 72 generates clipping region information such that a clipped image has as large an image size as possible. According to the clipping region information, the clipping portion 73 cuts out and generates clipped images 521, 522, 523 or 524 from the playback basic image, and outputs, to the display portion 27, the thus-generated one clipped image as the optimal composition adjustment image.

It has been described, in connection with the second or third composition-adjustment shooting operation, that shooting or clipping is performed with respect to any one of the first to fourth composition adjustment images that is selected; a composition adjustment image selected by using the same selecting method is handled as the optimal composition adjustment image. That is, based on the number of faces detected from the playback basic image, and based on the position, orientation and size of a face detected from the playback basic image, an optimal composition adjustment image is selected from the first to fourth composition adjustment images. Incidentally, in a case where a face detected from the playback basic image is oriented frontward, it is difficult to select only one optimal composition adjustment image, and thus a display to that effect is made on the display portion 27, and the process returns to step S51. Alternatively, a plurality of composition adjustment images, from which it is difficult to select only one optimal composition adjustment image, may be displayed side by side on the display screen of the display portion 27.

After the display of the optimal composition adjustment image in step S55, in the step S56, it is confirmed whether or not a replacement instruction has been given to instruct replacement of the recorded image. In a case where the replacement instruction has been given, under the control by CPU 23, the playback basic image is deleted from the external memory 18 in step S57, and thereafter, the optical composition adjustment image is recorded to the external memory 18 in step S59, and the process returns to step S51. In a case where no replacement instruction has been given, the process proceeds to step S58, where it is confirmed whether or not a recording instruction has been given to instruct separate recording of the optimal composition adjustment image. In a case where the recording instruction has been given, under the control by CPU 23, with the record of the playback basic image maintained, the optimal composition adjustment image is recorded to the external memory 18 in step S59, and then the process returns to step S51. In a case where the recording instruction has not been given, the process returns to step S51 with no performance of recording of the optimal composition adjustment image. Incidentally, in recording the optimal composition adjustment image, the image size of the optimal composition adjustment image may be increased to be equal to that of the playback basic image.

An image equivalent to the above-described optimal composition adjustment image can be obtained by executing software for image processing on a personal computer or the like, and performing trimming on the software, but the operation is complex. The above-described automatic-trimming playback operation makes it possible to view and record an optimal composition adjustment image (a highly artistic image) by quite a simple operation.

<<Modifications and Variations>>

The specific values given in the above descriptions are merely examples, which, needless to say, may be modified to any other values. In connection with the embodiments described above, modified examples or supplementary explanations will be given below in Notes 1 to 4. Unless inconsistent, any part of the contents of these notes may be combined with any other.

[Note 1]

In the above embodiments, the correction lens 36 is used as an optical member for moving, on the image sensor 33, an optical image projected on the image sensor 33. Instead of the correction lens 36, however, a vari-angle prism (not shown) may be used to realize the movement of the optical image. Alternatively, without using the correction lens 36 or a vari-angle prism, the above movement of the optical image may be realized by moving the image sensor 33 along a plane perpendicular to the optical axis.

[Note 2]

The automatic-trimming playback operation may be realized in an external image playback device (not shown) that is different from the imaging device 1. In this case, a face detection portion 71, a clipping region setting portion 72, and a clipping portion 73 are provided in the external image playback device, and image data of a playback basic image is given to the image playback device. A composition adjustment image from the clipping portion 73 provided in the image playback device is displayed either on a display portion that is equivalent to the display portion 27 and provided in the image playback device or on an external display device (all unillustrated).

[Note 3]

The imaging device 1 of FIG. 1 can be realized with hardware, or with a combination of hardware and software. In particular, the calculation processing necessary for performing the composition-adjustment shooting operation and the automatic-trimming playback operation can be realized with software, or with a combination of hardware and software. In a case where the imaging device 1 is built with software, a block diagram showing the blocks realized with software serves as a functional block diagram of those blocks. All or part of the calculation processing necessary for performing the composition-adjustment shooting operation and the automatic-trimming playback operation may be prepared in the form of a computer program to be executed on a program execution device (such as a computer), to thereby realize all or part of the calculation processing.

[Note 4]

For example, the following interpretations are possible. In the above-discussed embodiments, an image moving portion for moving, on the image sensor 33, an optical image projected on the image sensor 33 is realized by the correction lens 36 and the driver 34. In the performance of the above-described first or second composition-adjustment shooting operation, part including the shooting control portion 52 and the image acquisition portion 53 of FIG. 5 functions as a composition control portion which generates a composition adjustment image. In the performance of the above-described third composition-adjustment shooting operation, part including the clipping region setting portion 62 and the clipping portion 63 of FIG. 14 functions as a composition control portion which generates a composition adjustment image. In the performance of the above-described automatic-trimming playback operation, part including the clipping region setting portion 72 and the clipping portion 73 of FIG. 20 functions as a composition control portion which generates a composition adjustment image. Part including the portions referred to by reference numerals 71 to 73 of FIG. 20 functions as an image playback device. It may be thought that this image playback device further includes a display portion 27.

1. An imaging device, comprising:
an image sensor which outputs a signal corresponding to an optical image projected on the image sensor itself by shooting;
an image moving portion which moves the optical image on the image sensor;
a face detection portion which detects a face of a person as a subject from a judgment image which is based on an output signal of the image sensor, and detects a position and an orientation of the face on the judgment image; and
a composition control portion which performs control of the image moving portion based on a detected position and a detected orientation of the face, and generates a composition adjustment image from the output signal of the image sensor after the control.

2. The imaging device of claim 1,
wherein
the composition control portion controls the image moving portion such that a target point corresponding to the detected position of the face is placed at a specific position on the composition adjustment image, and the composition control portion sets the specific position based on the detected orientation of the face.

3. The imaging device of claim 2,
wherein
the composition control portion sets the specific position, with respect to a center of the composition adjustment image, close to a side opposite from a side toward which the face is oriented.

4. The imaging device of claim 2,
wherein
the specific position is any one of positions of four intersection points formed by two lines which divide the composition adjustment image in a horizontal direction into three equal parts and two lines which divide the composition adjustment image in a vertical direction into three equal parts.

5. The imaging device of claim 1,
wherein
the composition control portion generates one or more composition adjustment images as the composition adjustment image, and the composition control portion determines, based on the detected orientation of the face, a number of the composition adjustment images to be generated.

6. The imaging device of claim 5,
wherein, in a case where it is assumed that m is an integer of 2 or more and n is an integer of 2 or more but less than m,
in response to the face being detected to be oriented frontward, the composition control portion sets m specific positions which are different from each other, and generates a total of m composition adjustment images corresponding to the m specific positions,
and on the other hand, in response to the face being detected to be laterally oriented, the composition control portion sets one specific position and generates one composition adjustment image, or alternatively, the composition control portion sets n specific positions which are different from each other and generates a total of n composition adjustment images corresponding to the n specific positions.

7. The imaging device of claim 1, further comprising:
a shooting instruction receiving portion which receives a shooting instruction from outside; and
a record control portion which performs record control for recording, to a recording medium, image data based on the output signal of the image sensor,
wherein
the composition control portion generates the composition adjustment image according to the shooting instruction, and also generates, from the output signal of the image sensor, a basic image which is different from the composition adjustment image, and
the record control portion makes the recording medium record image data of the composition adjustment image and image data of the basic image such that the image data of the composition adjustment image and the image data of the basic image are associated with each other.

8. An imaging device, comprising:
an image sensor which outputs a signal corresponding to an optical image projected on the image sensor itself by shooting;
a face detection portion which detects a face of a person as a subject from a judgment image which is based on an output signal of the image sensor, and detects a position and an orientation of the face on the judgment image; and
a composition control portion which handles, as a basic image, the judgment image, or an image which is obtained from the output signal of the image sensor and which is different from the judgment image, and generates a composition adjustment image by cutting out part of the basic image,
wherein
the composition control portion controls a clipping position of the composition adjustment image based on a detected position and a detected orientation of the face.

9. The imaging device of claim 8,
wherein
the composition control portion controls the clipping position such that a target point corresponding to the detected position of the face is placed at a specific position on the composition adjustment image, and the composition control portion sets the specific position based on the detected orientation of the face.

10. The imaging device of claim 9,
wherein
the composition control portion sets the specific position, with respect to a center of the composition adjustment image, close to a side opposite from a side toward which the face is oriented.

11. The imaging device of claim 9,
wherein
the specific position is any one of positions of four intersection points formed by two lines which divide the composition adjustment image in a horizontal direction into three equal parts and two lines which divide the composition adjustment image in a vertical direction into three equal parts.

12. The imaging device of claim 8,
wherein
the composition control portion generates one or more composition adjustment images as the composition adjustment image, and the composition control portion determines, based on the detected orientation of the face, a number of the composition adjustment images to be generated.

13. The imaging device of claim 12,
wherein, in a case where it is assumed that m is an integer of 2 or more and n is an integer of 2 or more but less than m,
in response to the face being detected to be oriented frontward, the composition control portion sets m specific positions which are different from each other, and generates a total of m composition adjustment images corresponding to the m specific positions,
and on the other hand, in response to the face being detected to be laterally oriented, the composition control portion sets one specific position and generates one composition adjustment image, or alternatively, the composition control portion sets n specific positions which are different from each other and generates a total of n composition adjustment images corresponding to the n specific positions.

14. The imaging device of claim 8, further comprising:
a shooting instruction receiving portion which receives a shooting instruction from outside; and
a record control portion which performs record control for recording, to a recording medium, image data based on the output signal of the image sensor,
wherein
the composition control portion generates the basic image and the composition adjustment image according to the shooting instruction, and
the record control portion makes the recording medium record image data of the composition adjustment image and image data of the basic image such that the image data of the composition adjustment image and the image data of the basic image are associated with each other.

15. An image playback device, comprising:
a face detection portion which detects a face of a person from an input image, and detects a position and an orientation of the face on the input image; and
a composition control portion which outputs image data of a composition adjustment image obtained by cutting out part of the input image,
wherein
the composition control portion controls a clipping position of the composition adjustment image based on a detected position and a detected orientation of the face.

16. The imaging device of claim 2, wherein the composition control portion generates one or more composition adjustment images as the composition adjustment image, and the composition control portion determines, based on the detected orientation of the face, a number of the composition adjustment images to be generated.

17. The imaging device of claim 3, wherein the composition control portion generates one or more composition adjustment images as the composition adjustment image, and the composition control portion determines, based on the detected orientation of the face, a number of the composition adjustment images to be generated.

18. The imaging device of claim 4, wherein the composition control portion generates one or more composition adjustment images as the composition adjustment image, and the composition control portion determines, based on the detected orientation of the face, a number of the composition adjustment images to be generated.

19. The imaging device of claim 2, further comprising:
a shooting instruction receiving portion which receives a shooting instruction from outside; and
a record control portion which performs record control for recording, to a recording medium, image data based on the output signal of the image sensor,
wherein the composition control portion generates the composition adjustment image according to the shooting instruction, and also generates, from the output signal of the image sensor, a basic image which is different from the composition adjustment image, and
the record control portion makes the recording medium record image data of the composition adjustment image and image data of the basic image such that the image data of the composition adjustment image and the image data of the basic image are associated with each other.

20. The imaging device of claim 9, further comprising:
a shooting instruction receiving portion which receives a shooting instruction from outside; and
a record control portion which performs record control for recording, to a recording medium, image data based on the output signal of the image sensor,
wherein
the composition control portion generates the basic image and the composition adjustment image according to the shooting instruction, and
the record control portion makes the recording medium record image data of the composition adjustment image and image data of the basic image such that the image data of the composition adjustment image and the image data of the basic image are associated with each other.
